(19) United States
(12) Patent Application Publication
(10) Pub. No.: US 2007/0193086 A1
(43) Pub. Date: Aug. 23, 2007

(54) Display frame for two pictures changing at fixed positions

(75) Inventor: Tony Chuang, Taipei Hsien (TW)

Correspondence Address: BRUCE H. TROXELL;SUITE 1404, 5205 LEESBURG PIKE, FALLS CHURCH, VA, 22041, US

(73) Assignee: Trusty Industrial Inc.

(21) Appl. No.: 11/333,353

(22) Filed: Jan. 18, 2006

(51) Int. Cl. G09F 19/14

(52) U.S. Cl. 40/453

(57) ABSTRACT

A display frame for two pictures changing at fixed positions used as a picture frame or an advertisement billboard, it comprises a framework, two pictures, a grating plate, at least a magnet, an electric power source, a control circuit board and at least a coil; the pictures and the grating plate are assembled in the framework, the coil generates a specific magnetic force for moving the magnet, and angular positions of the pictures and the grating plate are changed, thereby effects that the two pictures on the grating plate are automatically changed and entirely presented in prolonged times are achieved.

### BACKGROUND OF THE INVENTION

1. Field of the Invention

The present invention is related to a display frame for two pictures changing at fixed positions used as a picture frame or an advertisement billboard, and especially to a display frame for two pictures in which the two different pictures can fast change automatically, and the pictures can be entirely presented for a long time.

2. Description of the Prior Art

Products each with an effect of changing of two or more than two pictures according to the principle of refraction of cylindrical mirror grating are more and more popularized; each product with two changing pictures originally has a grating plate clung on the pictures and thereafter a viewer moves to different angular viewing positions can see changing of the two pictures.

In order to meet the requirement of advertisement to elevate the visual effect and to attract people's eye sights, there have been various automatically picture changing frames developed. Although the mechanisms of them are more or less different, they all observe a principle, that is, in each case, the grating plate is separated from the pictures, a motor is provided to move either of the grating plate and the pictures, so that a viewer stay put at a position unmoved can see nonstop changing of the two pictures.

The conventional structure has two defects: one is that the motor is rotated with a fixed rotational speed, when an eccentrically rotating round member with an axle as a rotating center drives the pictures to make changing, the times for entirely presenting the pictures before they get into the processes of cross changing for changing picture are short, the important effect for customers to clearly see the contents of the advertisements hence is unable to get.

FIGS. 1A to 1E are schematic views showing the operations of a conventional motion frame for two pictures, wherein a round pushing leaf 903 around an eccentrically rotating axle 904 of a motor is placed at an opening of an article 901 to be moved, the article 901 to be moved can be connected with a grating plate or the pictures for angular changing.

In the drawings of FIGS. 1A to 1E, 902 indicates the horizontal line at the center of the rotating axle 904 of the motor, in the drawings the states of moving by rotating clockwise of the article 501 to be moved every 90 degrees around the rotating axle 504 of the motor are shown. We can see that the article 901 is moved always following the rotating of the rotating axle 904; i.e., the grating plate or the pictures change their angular presenting positions gradually to make the pictures change and present. By virtue that such a conventional structure takes advantage of the rotating eccentric pushing leaf 903 to render the two different pictures always to keep the processes of slowly cross changing, so that the times for entirely presenting the pictures are short, the effect for presenting the entire pictures in predetermined times can not be achieved.

### SUMMARY OF THE INVENTION

The main improvement of the present invention is that, the conventional mode to change the positions or angles of pictures or a grating plate by a moving force of a motor is changed to that one or more than one coil generates a specific magnetic force by means of a control circuit board for moving a magnet, and thereby effects that the two pictures are automatically changed and entirely presented in prolonged times can be achieved.

Another key point of designing of the present invention is to provide a movable coil-position adjusting device on a coil device to position the two pictures on the grating plate to be at their best angles and stop spots.

The present invention will be apparent after reading the detailed description of the preferred embodiment thereof in reference to the accompanying drawings.

### BRIEF DESCRIPTION OF THE DRAWINGS

FIGS. 1A to 1E are schematic views showing operations of a leaf in changing pictures of a conventional motion frame;

FIG. 2 is a side view of a first embodiment of an advertisement billboard with two changing pictures of the present invention;

FIG. 3 is a side view of a second embodiment of an advertisement billboard with two changing pictures of the present invention;

FIG. 3A is a bottom view of an “E” shaped plate of the second embodiment of the advertisement billboard with two changing pictures of the present invention;

FIG. 4 is side view of a third embodiment of an advertisement billboard with two changing pictures of the present invention;

FIG. 4A is a bottom view of an “L” shaped plate of the third embodiment of the advertisement billboard with two changing pictures of the present invention;

FIGS. 5A-5E are front views and schematic views showing assembling as well as partially enlarged perspective views of a fourth embodiment of an advertisement billboard with two changing pictures of the present invention;

FIGS. 6A to 6E are front views and schematic views showing assembling as well as partially enlarged perspective views of a fifth embodiment of an advertisement billboard with two changing pictures of the present invention;

FIGS. 7A to 7E are front views and schematic views showing assembling as well as partially enlarged perspective views of a sixth embodiment of an advertisement billboard with two changing pictures of the present invention;

FIGS. 8A to 8F are schematic views showing that a coil moves a magnet of the present invention;

FIGS. 9A and 9B are schematic views showing that a coil in FIG. 2 is used to adjust and change pictures at fixed positions;

FIGS. 10A and 10B are schematic views showing that a coil in FIG. 3 is used to adjust and change pictures at fixed positions;

FIGS. 11A and 11B are schematic views showing that a coil in FIG. 4 is used to adjust and change pictures at fixed positions;

FIGS. 12A and 12B are schematic views showing that a coil in FIGS. 5A-5E is used to adjust and change pictures at fixed positions;

FIGS. 13A and 13B are schematic views showing that a coil in FIGS. 6A-6E is used to adjust and change pictures at fixed positions;

FIGS. 14A and 14B are schematic views showing that a coil in FIGS. 7A-7E is used to adjust and change pictures at fixed positions;

FIG. 15 is a side view of another embodiment of an advertisement billboard of the present invention;

FIGS. 16A to 16D are front views and schematic views showing assembling as well as partially enlarged perspective views of a seventh embodiment of a picture frame with two changing pictures of the present invention;

FIG. 17 is a side view of an eighth embodiment of an advertisement billboard with two changing pictures of the present invention;

FIGS. 18A and 18B are schematic views showing that a coil in FIG. 17 is used to adjust and change pictures at fixed positions;

FIGS. 19A and 19B are schematic views showing that a magnetism conductive coil in FIG. 16A to 16D is used to adjust and change pictures at fixed positions;

FIGS. 20A to 20F are schematic views showing that a magnetism conductive coil moves a magnet of the present invention.

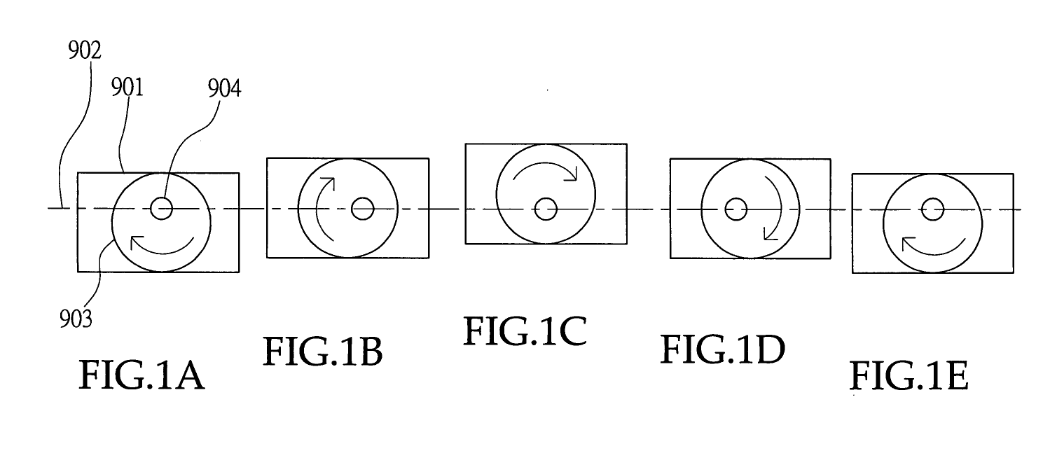

### DETAILED DESCRIPTION OF THE PREFERRED EMBODIMENT

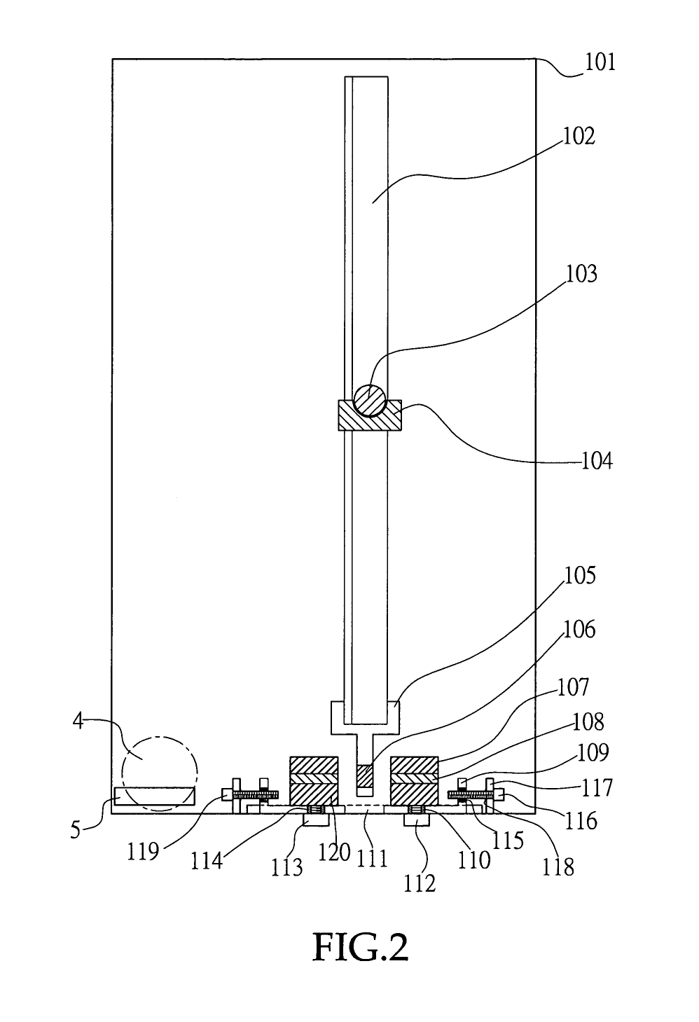

The first embodiment: being applied to an advertisement billboard, referring to FIG. 2, the present invention has a framework 101 of the advertisement billboard (a lateral side of the framework 101 is shown in FIG. 2), the framework 101 has therein semicircle recessed supporting seats 104 each fixed on one of two inner lateral sides of the framework 101 and has a grating plate 102 carrying pictures, at the middle of the grating plate 102, a clamping means with a round axle 103 is provided at each of two sides of the grating plate 102; the two round axles 103 are provided each with a bearing (not shown), and the grating plate 102 is provided on its bottom with a plain plate 105, the plain plate 105 is fixed thereon with a magnet 106; the two round axles 103 of the grating plate 102 are placed in the semicircle recessed supporting seats 104 of the framework 101, the grating plate 102 is naturally hung on the supporting seats 104; such a mechanical structure can allow a grating plate of even a larger size to have its angular position changed with a minimum external force. The framework 101 is provided on its bottom with necessary electric members including a control circuit board 5, a power source 4 for the control circuit board 5, a switch (not shown) etc. The plain plate 105 extending along the bottom of the grating plate 102 is provided at its right side with a coil 107; a silicon steel sheet 108 is mounted in the coil 107; the coil 107 is fixed on an “L” shaped movable slide plate 109 of which the bottom has a nut 110 fixed thereon, the movable slide plate 109 is mounted and fixed in two protruding rails 111 on the framework 101 to limit its direction of movement. A movable screw 112 is extended from outside of the bottom of the framework 101 through a rectangular hole (not shown) of the framework 101 to be locked in the nut 110 of the “L” shaped movable slide plate 109; the position of the coil 107 can be adjusted by moving the movable screw 112. The “L” shaped movable slide plate 109 can also be provided on one end thereof with a nut 115, a movable screw 116 is extended from a stub 117 protruding out of the framework 101 to be locked in the nut 115. A “C” shaped annulus 118 grips the movable screw 116 on one side of the stub 117; the coil 107 can also be adjusted by rotating the movable screw 116. The plain plate 105 extending along the bottom of the grating plate 102 is provided at its left side also with a coil 120; two screws 113, 119 are used to control the coil 120. The way how the coils 107 and 120 change the angle of the grating plate 102 carrying pictures, and thereby how the effects that the pictures are changed in a short time and entirely presented in long times can be achieved will be narrated hereinafter.

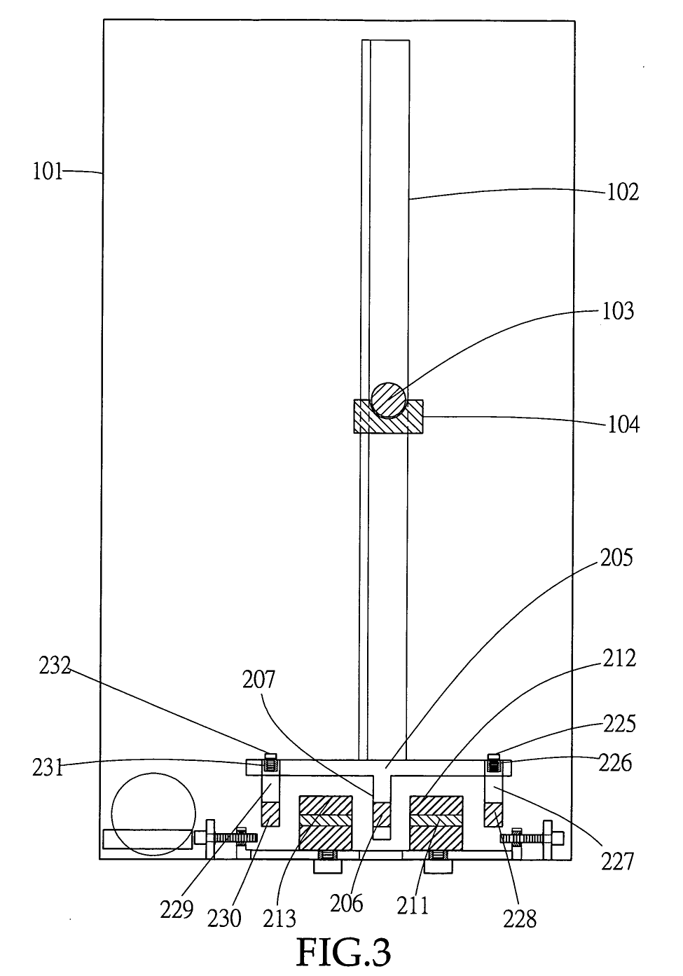

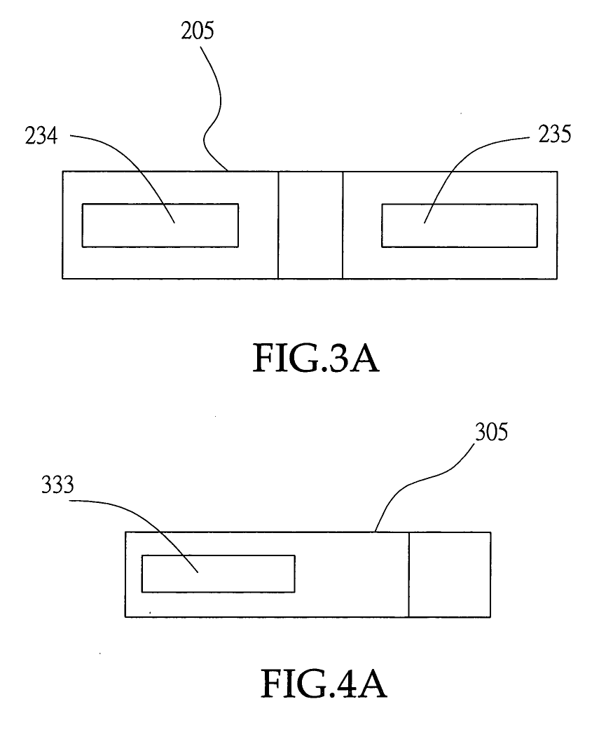

The second embodiment: referring to FIG. 3, the framework 101, the grating plate 102, the round axles 103 and the semicircle recessed supporting seats 104 are same as those of the first embodiment, but the plain plate 105 fixed on the grating plate 102 is changed to an “E” shaped plate 205; a middle plain plate 207 which is fixedly connected to the middle of and beneath the “E” shaped plate 205 and is fixed thereon with a magnet 206; the “E” shaped plate 205 is provided on its right end with a movable plain plate 227 which is fixed thereon with a magnet 228 just as the way of the middle plain plate 207, and is provided on its top with a nut 226. The movable plain plate 227 is mounted in a rectangular hole 235 (referring to FIG. 3A) on the “E” shaped plate 205 with a movable screw 225 into the nut 226. The “E” shaped plate 205 is provided on its left end also with a movable plain plate 229 which is mounted in another rectangular hole 234 (referring to FIG. 3A); and is locked in a nut 231 on the movable plain plate 229 with another movable screw 232. The way how the coils 212 and 213 change the angle of the grating plate 102 carrying pictures, and thereby how the effects that the pictures are changed in a short time and entirely presented in long times can be achieved will be narrated hereinafter.

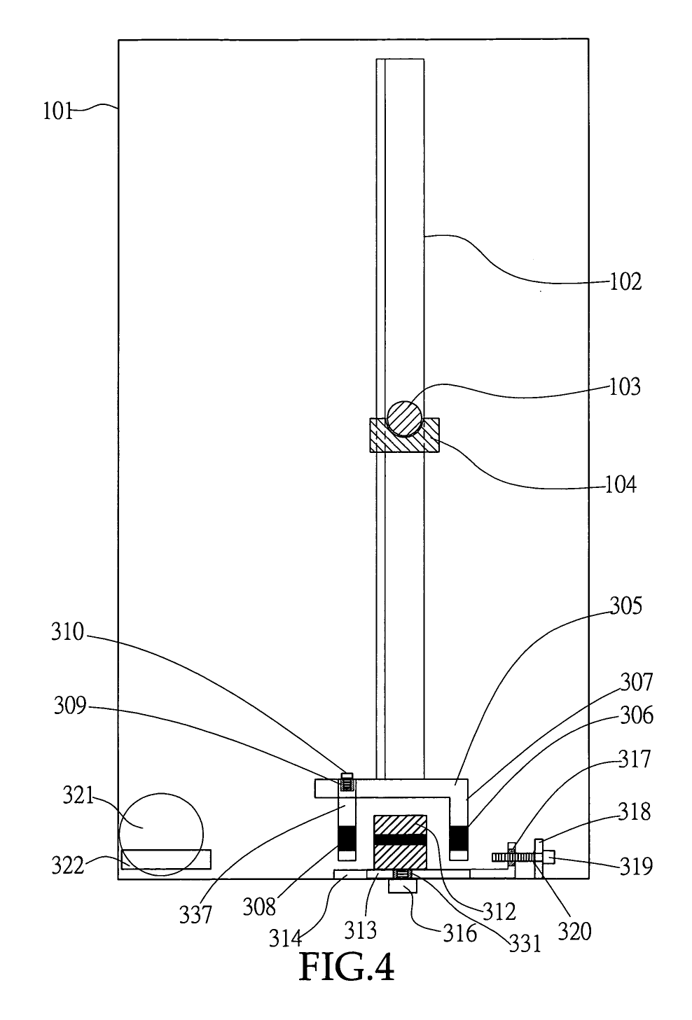

The third embodiment: referring to FIG. 4, the framework 101 of the second embodiment is changed to be mounted with a coil 312, a movable means composed of rails 314, an “L” shaped movable slide plate 313, a movable screw 316, a nut 331, a nut 317, a stub 318, a movable screw 319 and a “C” shaped annulus 320 is same as that of the first embodiment. The plain plate 105 fixed on the grating plate 102 is changed to a “U” shaped plate 305 with a fixed plain plate 307 on its right end having thereon a fixed magnet 306. The “U” shaped plate 305 is provided on its left end with a movable plain plate 337 which is same as those movable plain plates in the second embodiment and which is mounted in a rectangular hole 333 (referring to FIG. 4A) at the left side of the “U” shaped plate 305; and is locked in a nut 309 on the movable plain plate 337 with another movable screw 310. The way how the coil 312 changes the angle of the grating plate carrying pictures, and thereby how the effects that the pictures are changed in a short time and entirely presented in long times can be achieved will be narrated hereinafter.

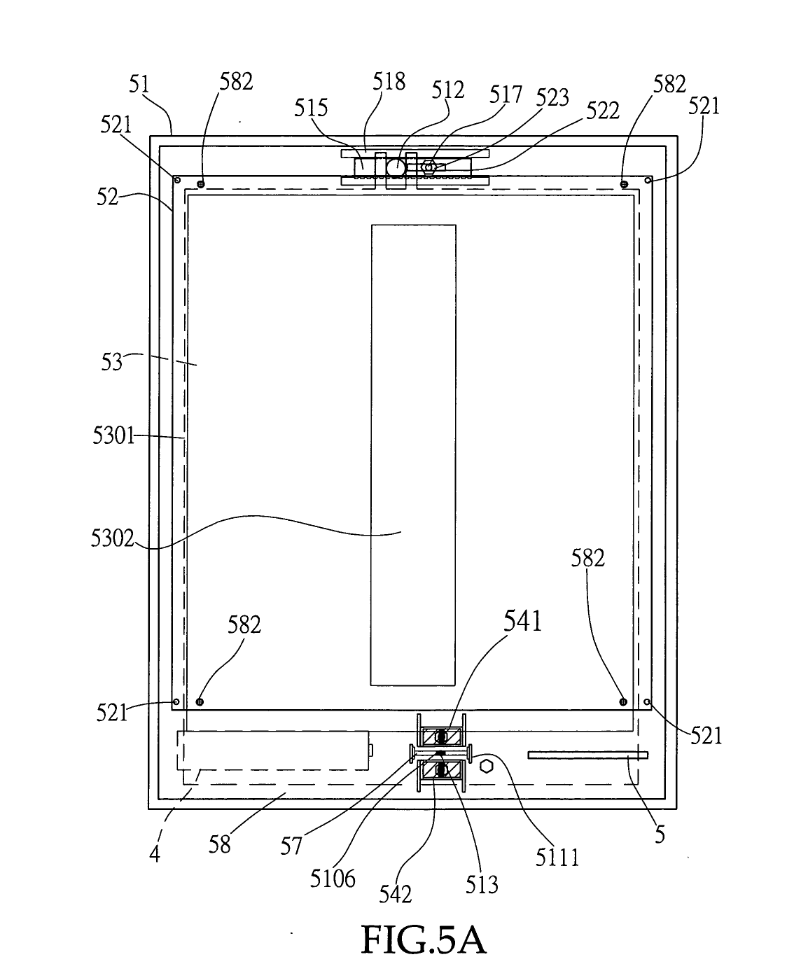

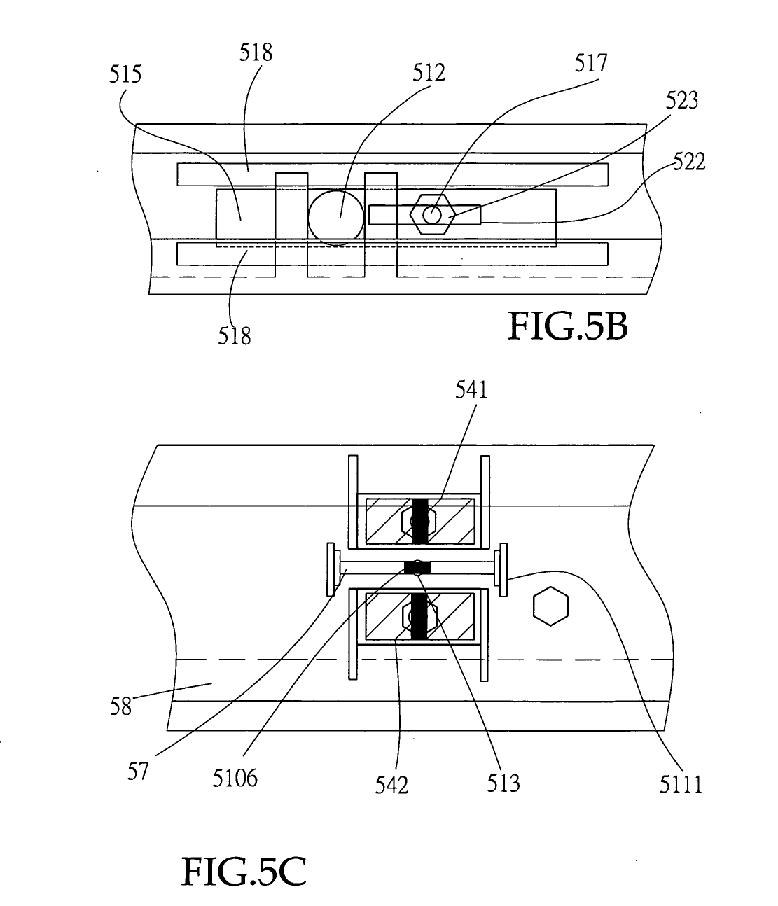

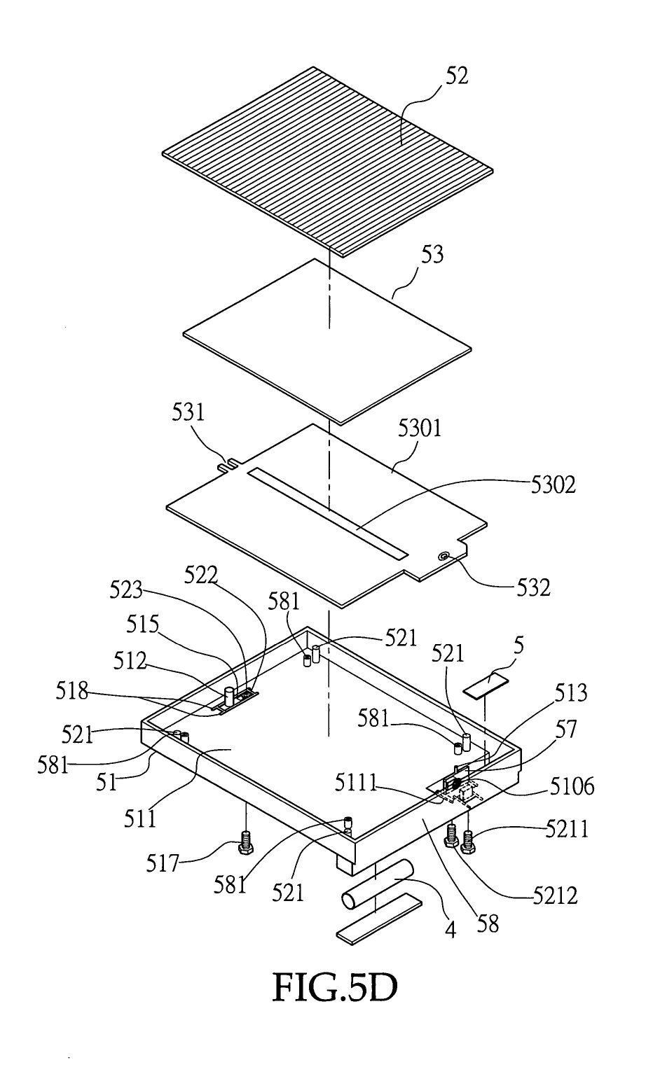

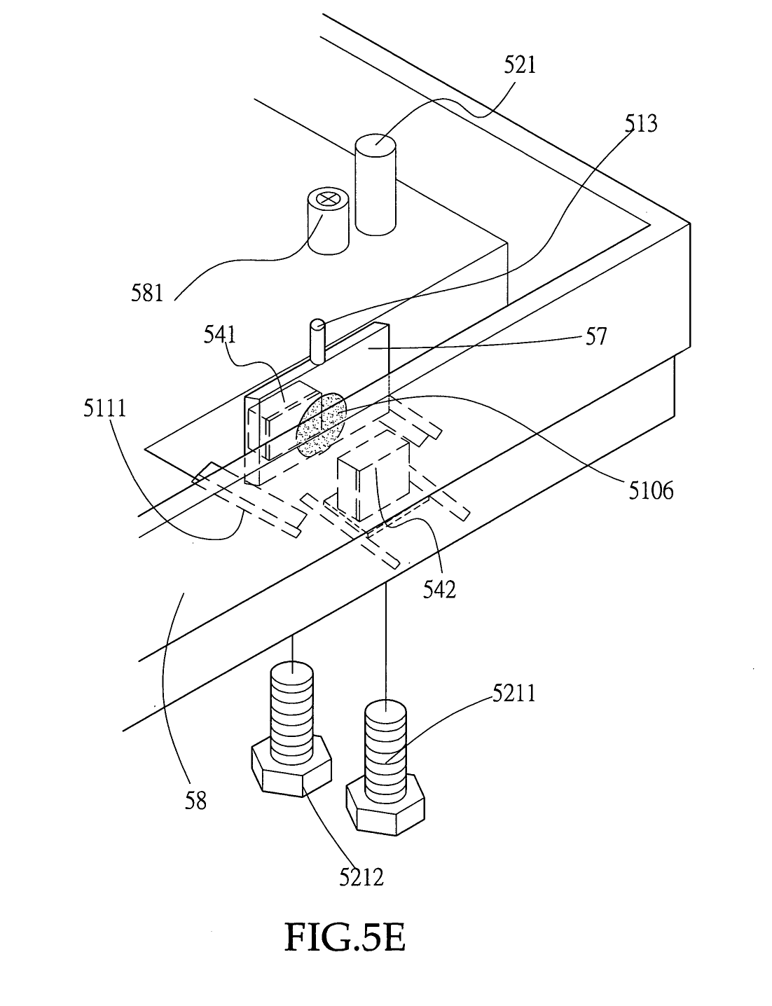

The fourth embodiment: being applied to a picture frame, the embodiment has three main elements including a framework, a back plate and a tripod, and mainly has improvement on the back plate; referring to FIGS. 5A-5E; the back plate 51 has therein a recessed space 511, and has on its upper end a slide plate 515; the slide plate 515 is mounted and fixed in two protruding rails 518 on the main body of the back plate 51 to limit its direction of movement, and is provided with a protruding cylindrical column 512; a fixing nut 523 allows a screw 517 to be extended from outside of the bottom of the main body of the back plate 51 through a rectangular hole 522 of the back plate 51 and to be locked in the nut 523. The main body of the back plate 51 totally has four protruding cylindrical columns 521 at four corners of it in order to support a grating plate 52 to keep a suitable distance from pictures 53 below; further there are four shorter protruding cylindrical columns 581 provided near and inwardly of the four protruding cylindrical columns 521, for each of the protruding cylindrical columns 581 a movable screw 582 is locked thereon to support a plain plate 5301 for sticking thereon pictures, the pictures 53 are stuck with a double sided adhesive tape 5302 onto the plain plate 5301; the back plate 51 has on its bottom end a recessed area 58 for mounting therein with necessary electric members including a control circuit board 5, a power source 4 for the control circuit board 5, a switch (not shown) etc. A middle movable plate 57 is mounted in two protruding rails 5111 fixed on the main body of the back plate 51 to limit its direction of movement; the middle movable plate 57 is fixedly mounted in the middle of it with a magnet 5106, and is provided on its top with a protruding cylindrical column 513, the middle movable plate 57 is provided at its two lateral sides respectively with a coil 541 (542) same as those of the first embodiment, the mode of operation of the coils 541, 542 as well as the movable screws are also same. In assembling, a notch 531 on the top of the plain plate 5301 with the pictures 53 is slipped over the protruding cylindrical column 512, while a lower hole 532 is slipped over the protruding cylindrical column 513, then the grating plate 52 is placed over the pictures 53 to be supported by the four protruding cylindrical columns 521, and to be unmoved by tightly and fixedly clamping by the edges of the main body of the back plate 51; at this time, if the tightness of contact of the pictures 53 with the grating plate 52 is not appropriate, the grating plate 52 and the plain plate 5301 with the pictures 53 can be removed to adjust their positions to be higher or lower to get the best tightness, and then micro-adjustment leftwards or rightwards of the screw 517 at an outer position on the bottom of the back plate 51 (FIG. 5A) can be done, and the angular position of the pictures 53 can be changed. When specific veins on the pictures 53 are parallel to those of the grating plate 52, the pictures 53 get their correct angular position, now the screw 517 can be tightened to finish the operation. The way how the coils 541 and 542 change the angle of the grating plate 52 carrying pictures 53, and how the effects that the pictures 53 are changed in a short time and entirely presented in long times can be achieved will be narrated hereinafter.

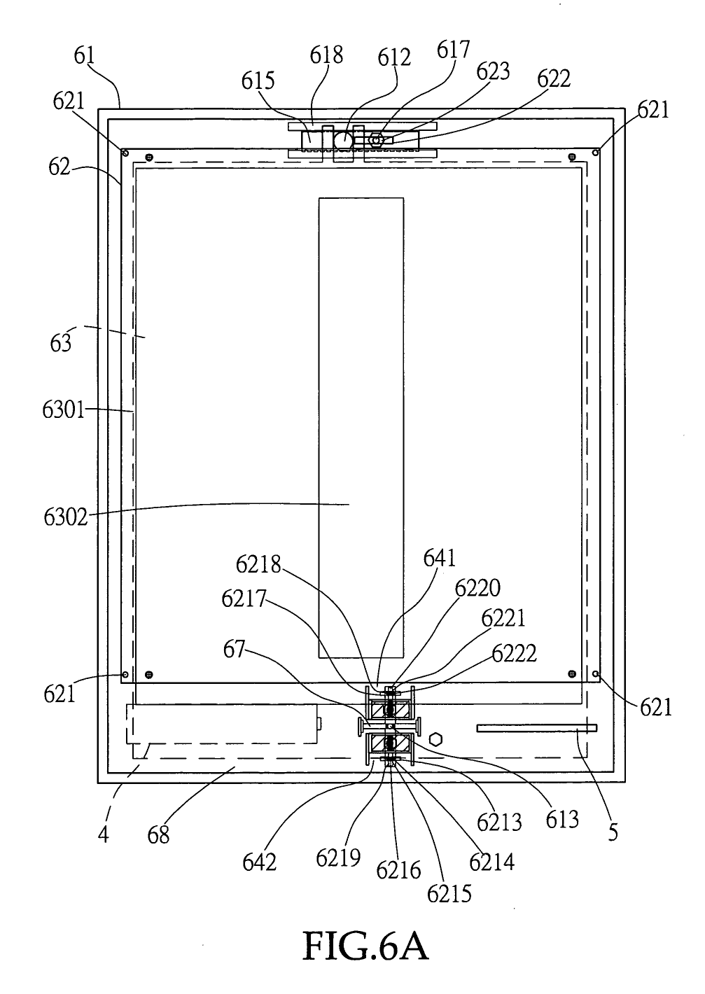

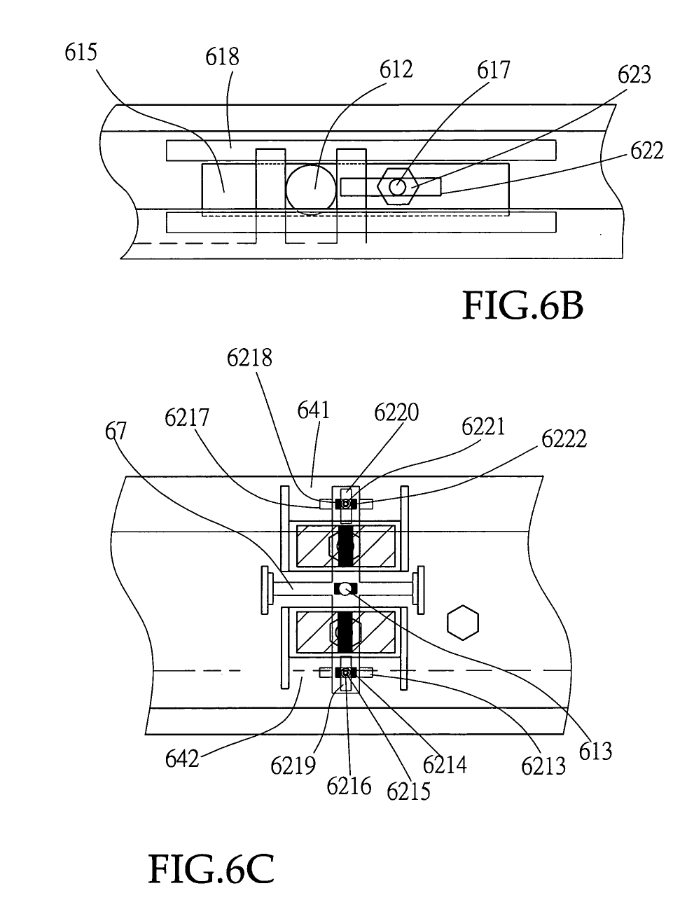

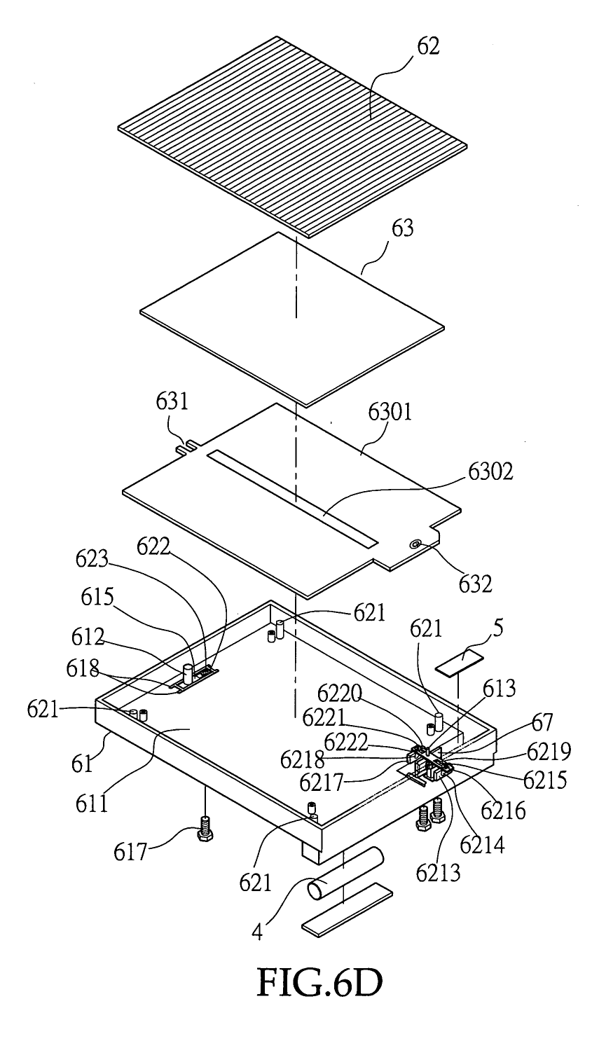

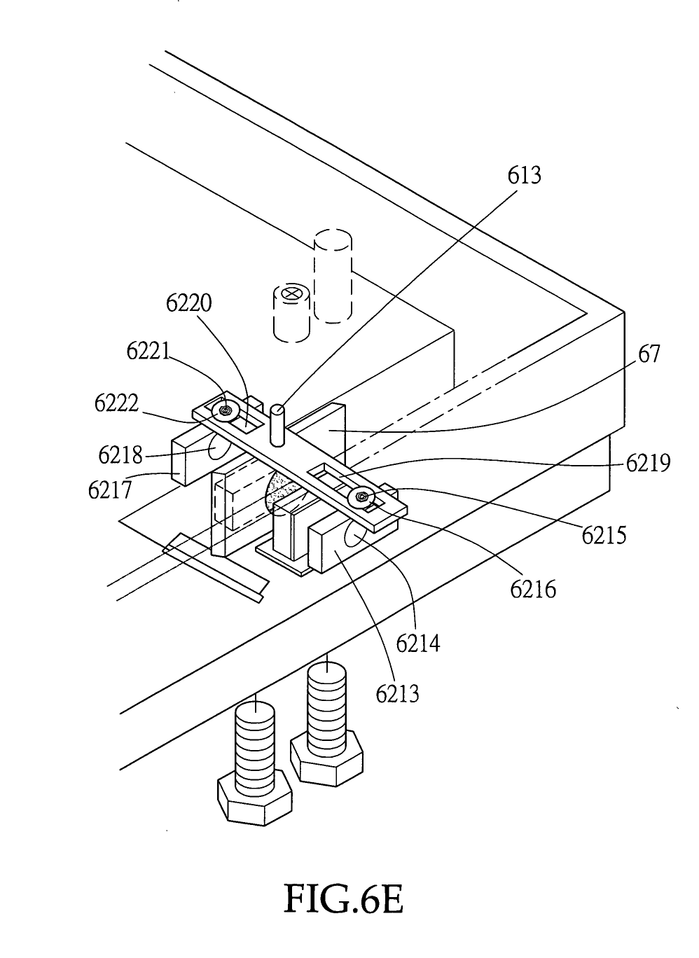

The fifth embodiment: referring to FIGS. 6A-6E, the movable plate 57 of the fourth embodiment is changed to an “E” shaped plate 67, the “E” shaped plate 67 is mounted at its two lateral sides with two movable plain plates 6213 and 6217 just as those of the second embodiment, two movable screws 6216 and 6222 are locked in two nuts 6215 and 6221 on the two movable plain plates 6213 and 6217 respectively. The way how coils change the angle of a grating plate 62 carrying pictures, and how the effects that the pictures are changed in a short time and entirely presented in long times can be achieved will be narrated hereinafter.

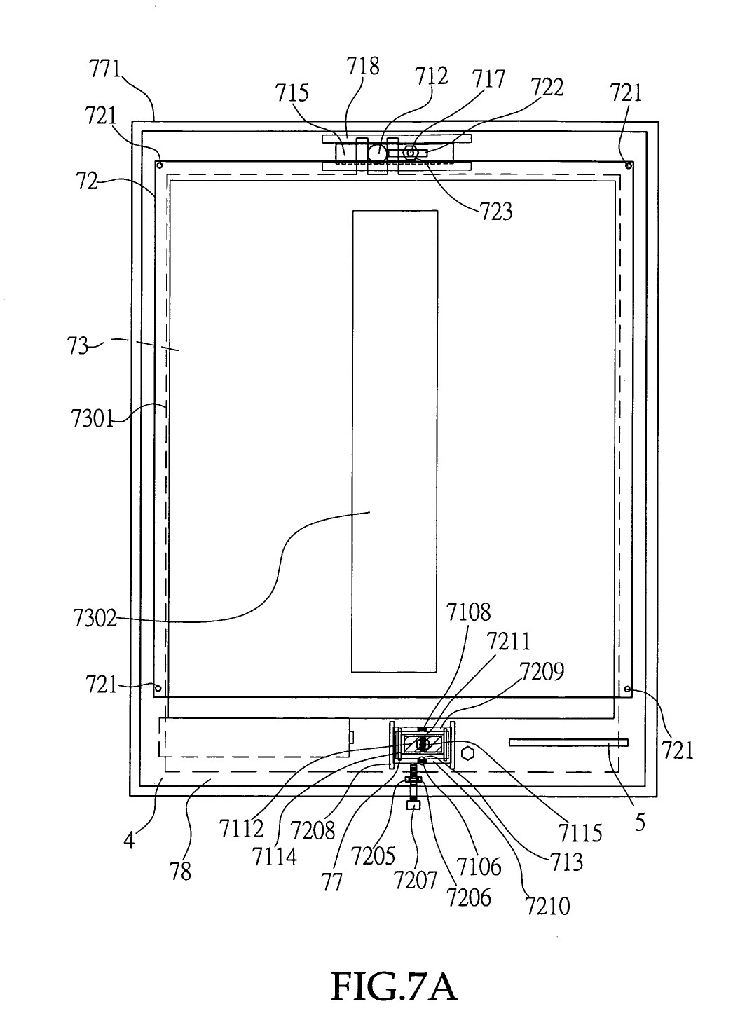

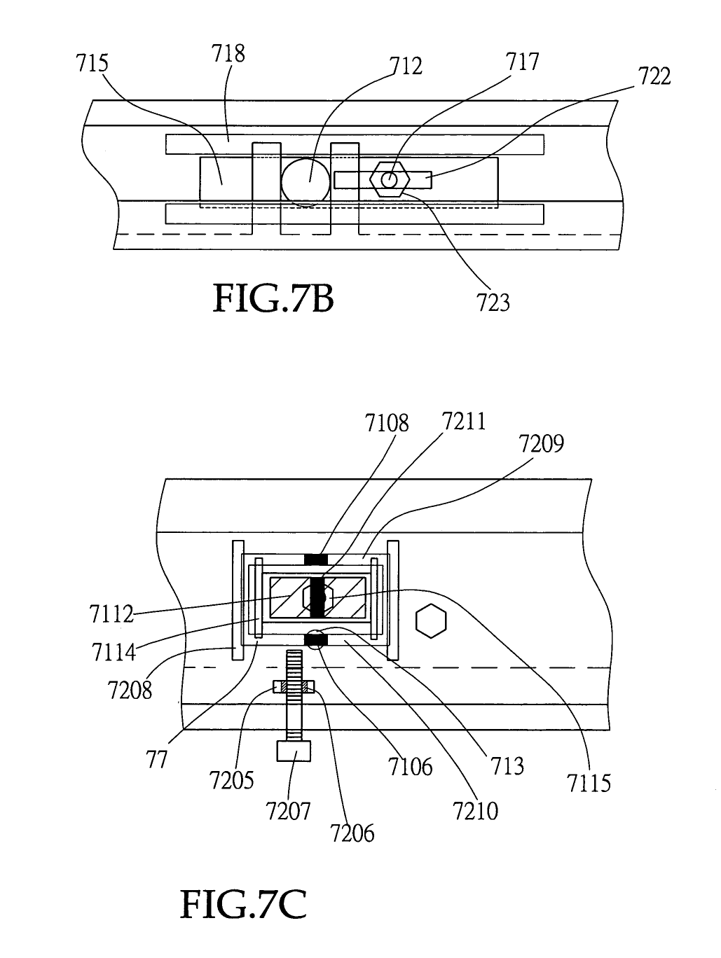

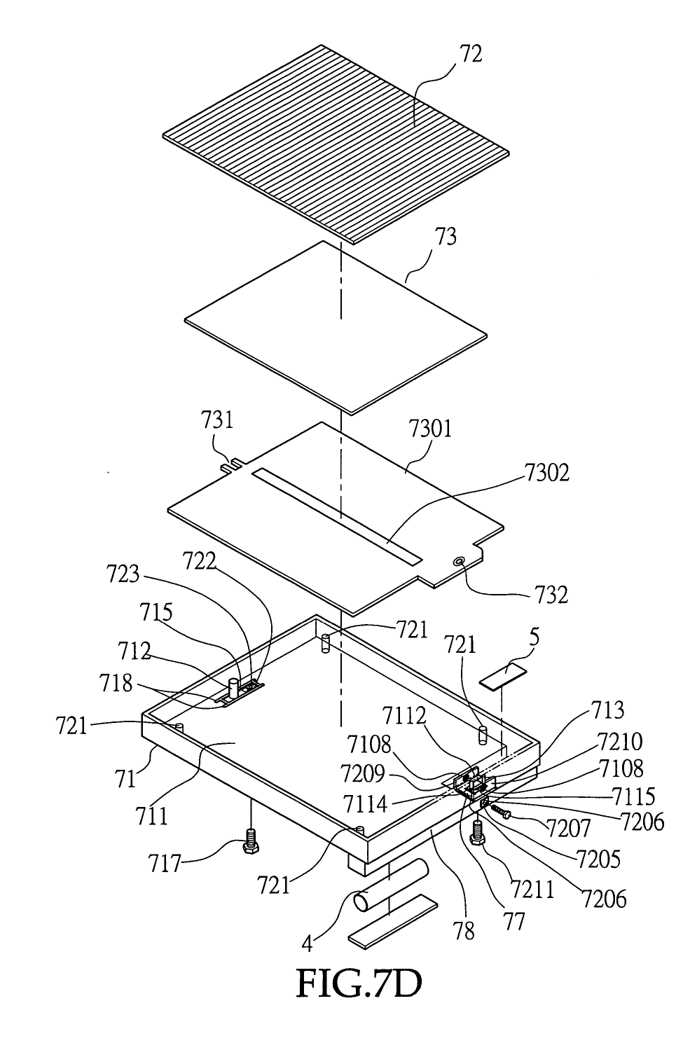

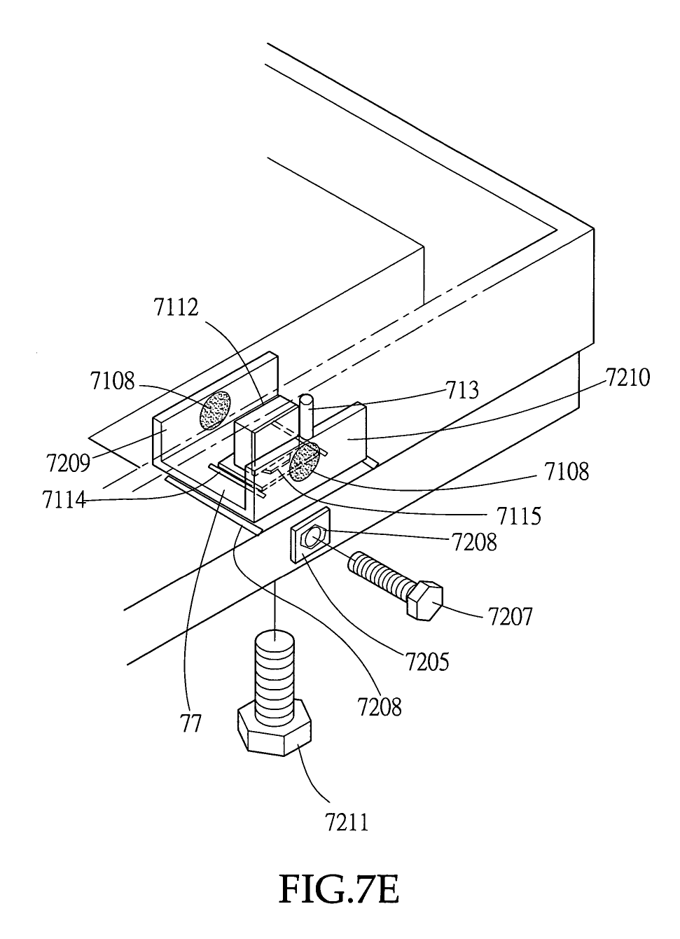

The sixth embodiment: referring to FIGS. 7A and 7B, the two coils of the fourth embodiment is changed to a coil 7112 having in the middle of it a silicon steel sheet (magnetism conductive medium), a movable means is same as that of the fourth embodiment, the movable plate 57 of the fourth embodiment is changed to a movable “U” shaped plate 77 formed by combining of two plain plates 7209, 7210 and is mounted and fixed in two protruding rails 7208 on the back plate, and two magnets 7108 and 7106 on the two plain plates 7209, 7210 are provided at the two lateral sides respectively of the coil 7112; the bottom of the back plate has on its inner side a protruding rectangular sheet 7205 which has a nut 7206 fixed thereon, a movable screw 7207 is extended from outside through the bottom of the back plate to be locked in the nut 7206. The way how the coil 7112 changes the angle of a grating plate 72 carrying pictures, and how the effects that the pictures are changed in a short time and entirely presented in long times can be achieved will be narrated hereinafter.

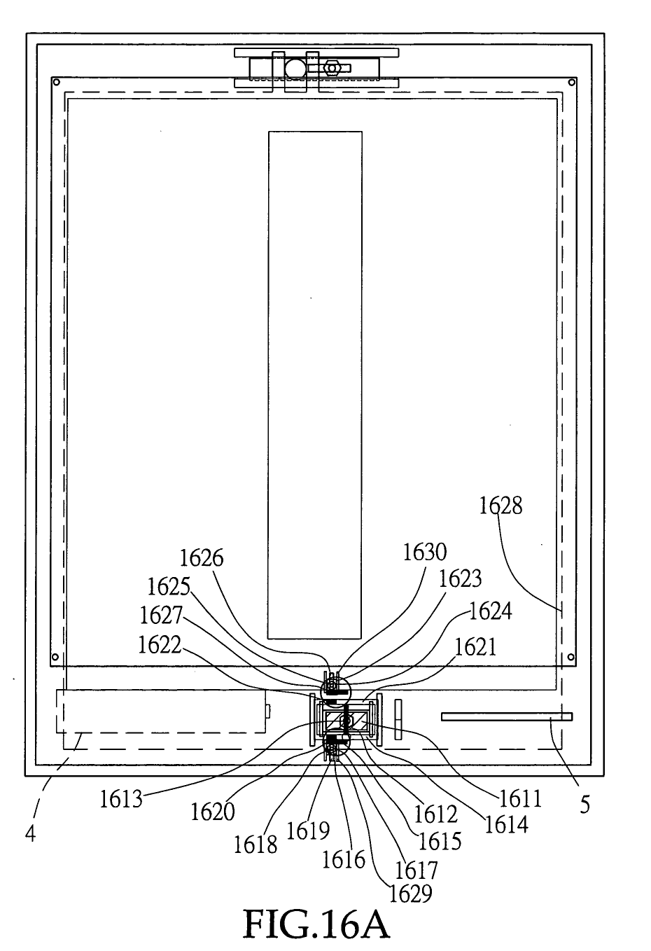

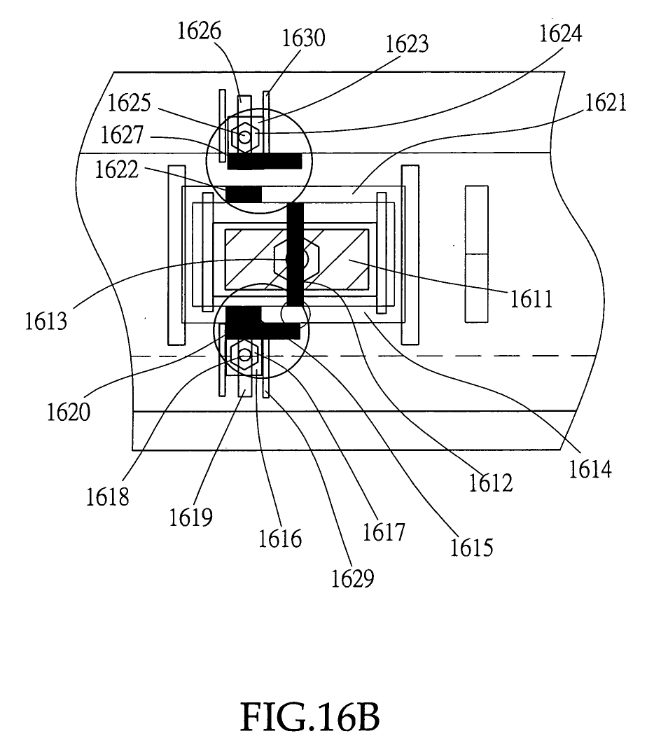

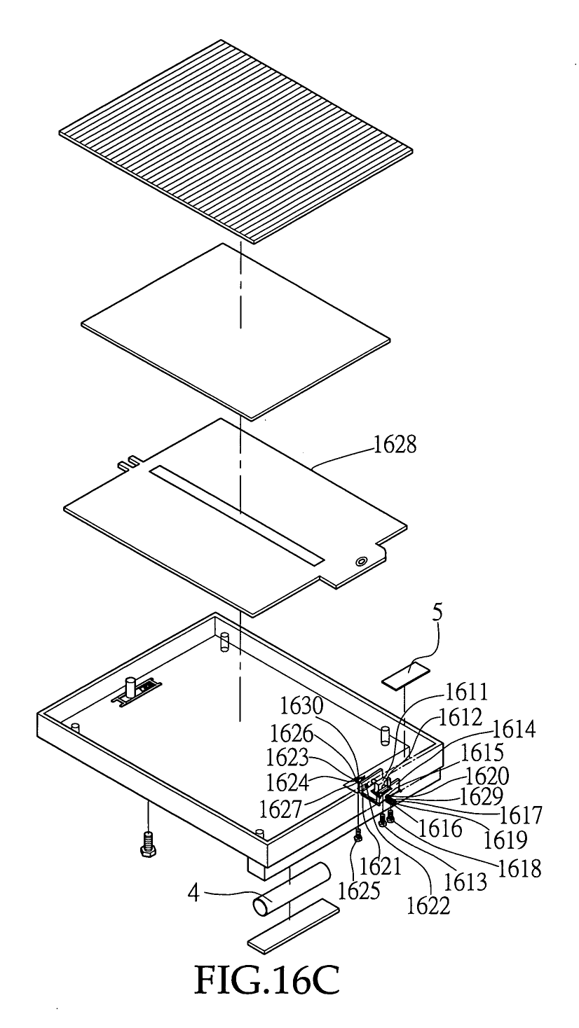

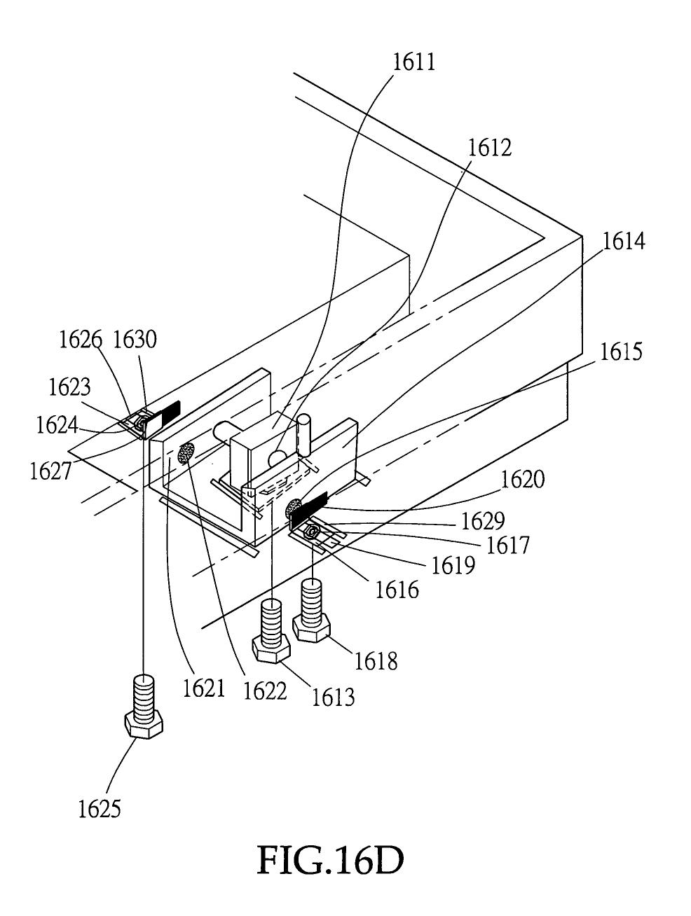

The seventh embodiment: referring to FIGS. 16A and 16B, a silicon steel sheet (magnetism conductive medium) in the middle of a coil 7112 of the movable means in the sixth embodiment is changed to a cylindrical magnet 1612 in the middle of a coil 1611; polarities of the magnet 1612 are half N polarity and half S polarity, the coil 1611 has its position adjusted and fixed with a screw 1613 extended from outside through the bottom of the back plate; a lower plain plate 1614 of a “U” shaped plate has a magnet 1615 fixed thereon; an “L” shaped movable plate 1616 below the magnet 1615 has a nut 1617 fixed thereon to be locked with a screw 1618 extended through an elongate hole 1619 on the bottom of the back plate; the “L” shaped movable plate 1616 has an iron sheet 1620 fixed at its lateral side, the length of the iron sheet 1620 reaches the range of attraction of the two magnets 1615 and 1612, the “L” shaped movable plate 1616 is mounted in two protruding rails 1629 on the back plate to limit its direction of movement; an upper plain plate 1621 of the “U” shaped plate has a magnet 1622 fixed thereon too, an “L” shaped movable plate 1623 above the magnet 1622 has a nut 1624 fixed thereon to be locked with a screw 1625 extended through an elongate hole 1626 on the bottom of the back plate; the “L” shaped movable plate 1623 has an iron sheet 1627 fixed at its lateral side, the length of the iron sheet 1627 reaches the range of attraction of the two magnets 1622 and 1612, the “L” shaped movable plate 1623 is mounted in two protruding rails 1630 on the back plate to limit its direction of movement. The way how the coil 1611 changes the angle of a grating plate carrying pictures, and how the effects that the pictures are changed in a short time and entirely presented in long times can be achieved will be narrated hereinafter.

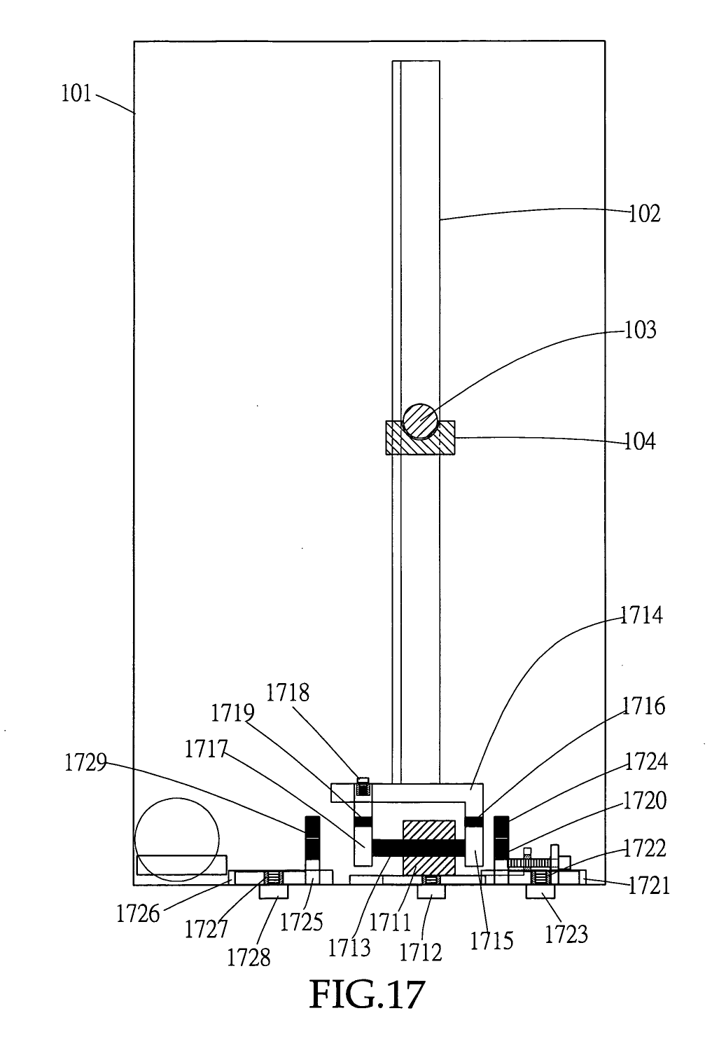

The eighth embodiment: referring to FIG. 17, a silicon steel sheet in the middle of a coil 1711 same as the silicon steel sheet in the middle of the coil 312 of the movable means in the third embodiment is changed to a cylindrical magnet 1713; polarities of the magnet 1612 are half N polarity and half S polarity, the coil 1711 has its position adjusted and fixed with a screw 1712 extended from outside through the bottom of the back plate; a “U” shaped plate 1714 with a fixed plain plate 1715 on its right end has thereon a fixed magnet 1716, an “L” shaped movable plate 1720 at the right of the magnet 1716 has a nut 1722 fixed thereon to be locked with a screw 1723 extended through an elongate hole (not shown) on the bottom of the framework; the “L” shaped movable plate 1720 has an iron sheet 1724 fixed at its lateral side, the length of the iron sheet 1724 reaches the range of attraction of the two magnets 1713 and 1716, the “L” shaped movable plate 1720 is mounted in two protruding rails 1721 on the back plate to limit its direction of movement; the “U” shaped plate 1714 with a movable plain plate 1717 on its left is locked on the “U” shaped plate 1714, and also has thereon a fixed magnet 1719, an “L” shaped movable plate 1725 at the left of the magnet 1719 has a nut 1727 fixed thereon to be locked with a screw 1728 extended through an elongate hole (not shown) on the bottom of the framework; the “L” shaped movable plate 1725 has an iron sheet 1729 fixed at its lateral side, the length of the iron sheet 1729 reaches the range of attraction of the two magnets 1713 and 1719, the “L” shaped movable plate 1725 is mounted in two protruding rails 1726 on the back plate to limit its direction of movement. The way how the coil 1711 changes the angle of a grating plate carrying pictures, and how the effects that the pictures are changed in a short time and entirely presented in long times can be achieved will be narrated hereinafter.

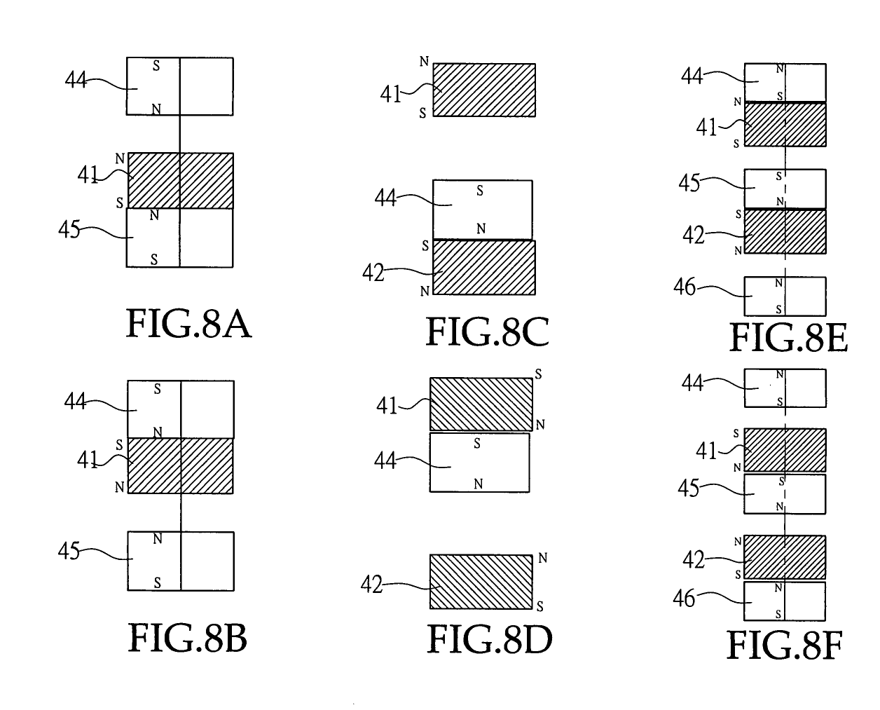

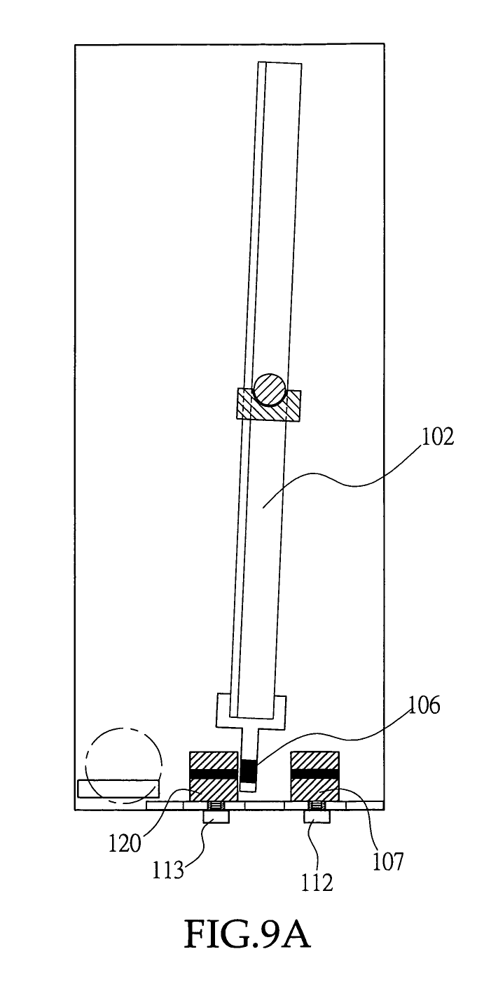

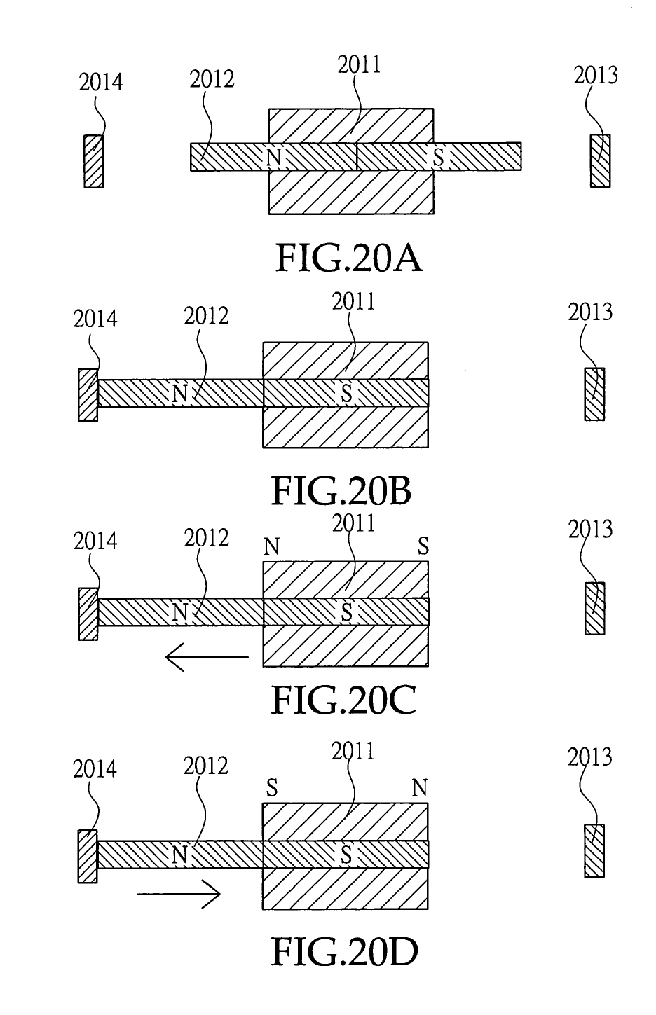

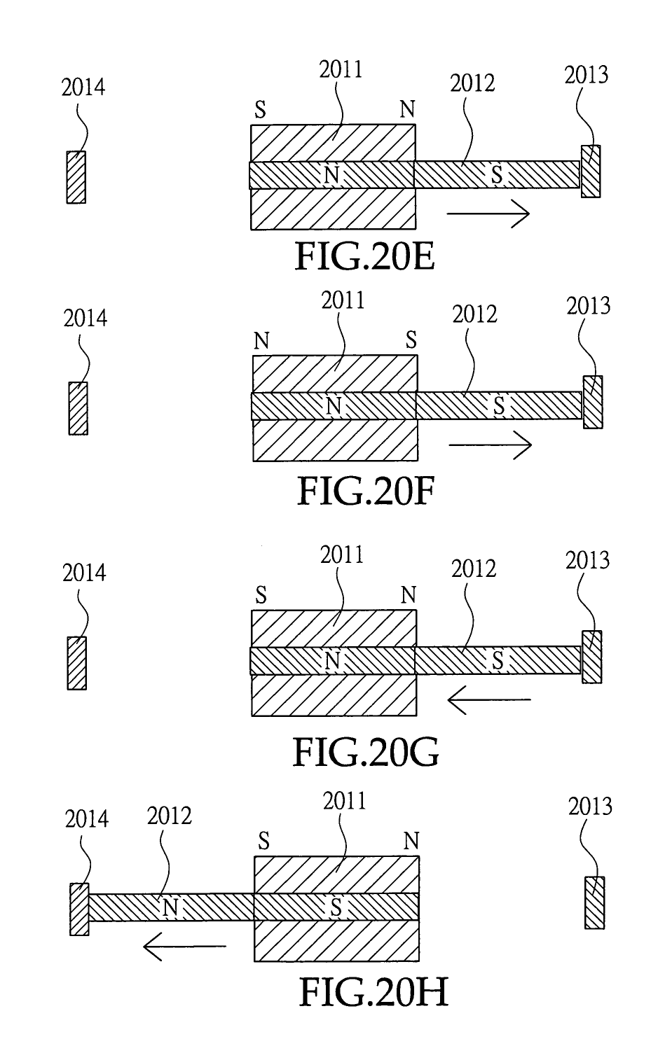

Before explaining how the eighth embodiment makes the grating plate change two pictures, let us explain in advance how the coil moves the magnet according to the principle “like charges repel each other while unlike charges attract each other”, referring to FIG. 8A, a coil 41 has above and below it respectively a magnet 45 and a magnet 46 connected with each other, the N polarities of the two magnets both face to the coil 41; assuming that a control circuit board first time supplies electric current for the coil 41, the upper end of the coil 41 generates an N polarity, while the lower end is an S polarity; the upper magnet 44 will be repelled by the coil 41, while the lower magnet 45 will be attracted by the coil 41. Referring to FIG. 8B, when the control circuit board second time supplies electric current for the coil 41, the upper end of the coil 41 generates an S polarity, while the lower end is an N polarity; the upper magnet 44 will be attracted by the coil 41, while the lower magnet 45 will be repelled by the coil 41. Referring to FIG. 8C, the upper end of the magnet 44 is an S polarity, while its lower end is an N polarity; the coil 41 is at an upper position, while a coil 42 is at a lower position; assuming that the control circuit board first time supplies electric current for the coils 41, 42, the ends of the coils 41, 42 closer to the magnet 44 generates S polarities, while the lower end of the magnet 44 is an N polarity to be attracted by the lower coil 42 and repelled by the upper coil 41 naturally. When the control circuit board second time supplies electric current for the coils 41, 42, the ends of the coils 41, 42 closer to the magnet 44 both generate N polarities, referring to FIG. 8D, the lower end of the magnet 44 is an N polarity to be repelled by the lower coil 42 and attracted by the upper coil 41 naturally. Referring to FIG. 8E, the coils 41, 42 are kept away for a distance, the magnet 45 with its upper end of an S polarity and its lower end of an N polarity is mounted between the coils 41, 42; the outsides of the coils 41, 42 are neighbored respectively with a magnet 44 and a magnet 46 in connection with the magnet 45; the magnet 44 is mounted to have its lower end of an S polarity neighbored with the coil 41, while the magnet 46 is mounted to have its upper end of an N polarity neighbored with the coil 42. Assuming that a control circuit board first time supplies electric current for the coils 41, 42, the ends of the two coils 41, 42 closer to the magnet 45 generate S polarities, while the other ends are N polarities; the magnet 44 will be attracted by the coil 41, while the magnet 45 will be repelled by the coil 41 but attracted by the coil 42; the magnet 46 will be repelled by the coil 42. Referring to FIG. 8F, when the control circuit board second time supplies electric current for the coils 41, 42, the ends of the two coils 41, 42 closer to the magnet 45 generate N polarities, while the other ends are S polarities; the magnet 44 will be repelled by the coil 41, while the magnet 45 will be attracted by the coil 41 but repelled by the coil 42; the magnet 46 will be attracted by the coil 42. Further referring to FIG. 20A, 2011 indicates a coil, 2012 indicates a cylindrical magnet with an N polarity in its left half part and with an S polarity in its right half part and extending through the center of the coil 2011; 2013 and 2014 indicate two iron sheets for impeding and being adsorbed by the cylindrical magnet 2012; when the N polarity and the S polarity are equal to each other in the ranges of the coil 2011, no matter which kind of magnetism is generated respectively at the two ends of the coil 2011, their forces of repelling or attracting will be offset because of equality of the forces. Referring to FIG. 20B, if the magnet 2012 is moved leftwards to be adsorbed by the iron sheet 2014, assuming that the control circuit board first time supplies electric current for the coil 2011 to render the left end of the coil 2011 to generate an N polarity and the right end is an S polarity naturally, referring to FIG. 20C; at this time, the N polarity on the left end of the coil 2011 will repel the N polarity on the magnet 2012 outside of the coil 2011 and will attract the S polarity on the magnet 2012 inside of the coil 2011; meantime, the S polarity on the right end of the coil 2011 will repel the S polarity on the magnet 2012, hence the magnet 2012 gets a moving power to the left but it is stopped by the iron sheet 2014; when the control circuit board second time supplies electric current for the coils 2011 to render the left end of the coil 2011 to generate an S polarity and the right end is an N polarity naturally, referring to FIG. 20D; at this time, the S polarity on the left end of the coil 2011 will attract the N polarity on the magnet 2012 outside of the coil 2011 and will repel the S polarity on the magnet 2012 inside of the coil 2011; meantime, the N polarity on the right end of the coil 2011 will attract the S polarity on the magnet 2012, hence the magnet 2012 gets a moving power to rush to the right, its inertia effect removes the obstacle as stated above for FIG. 20 to go on moving rightwards until it is stopped by the iron sheet 2013, such as is shown in FIG. 20E. When the control circuit board once more supplies electric current for the coils 2011 to render the left end of the coil 2011 to generate an N polarity and the right end is an S polarity naturally, referring to FIG. 20F; the S polarity on the right end of the coil 2011 will repel the S polarity on the magnet 2012 and will attract the N polarity on the magnet 2012 inside of the coil 2011; meantime, the N polarity on the left end of the coil 2011 will repel the N polarity on the magnet 2012 too, hence the magnet 2012 gets a moving power to the right again, but it is stopped by the iron sheet 2013. When the control circuit board once more supplies electric current for the coils 2011 to render the left end of the coil 2011 to generate an S polarity and the right end is an N polarity naturally, referring to FIG. 20G; at this time, the S polarity on the left end of the coil 2011 will attract the N polarity on the magnet 2012 inside of the coil 2011; meantime, the N polarity on the right end of the coil 2011 will repel the S polarity on the magnet 2012 and will attract the S polarity on the magnet 2012 outside of the coil 2011; hence the magnet 2012 gets a moving power to rush to the left until it is stopped by the iron sheet 2014, such as is shown in FIG. 20H.

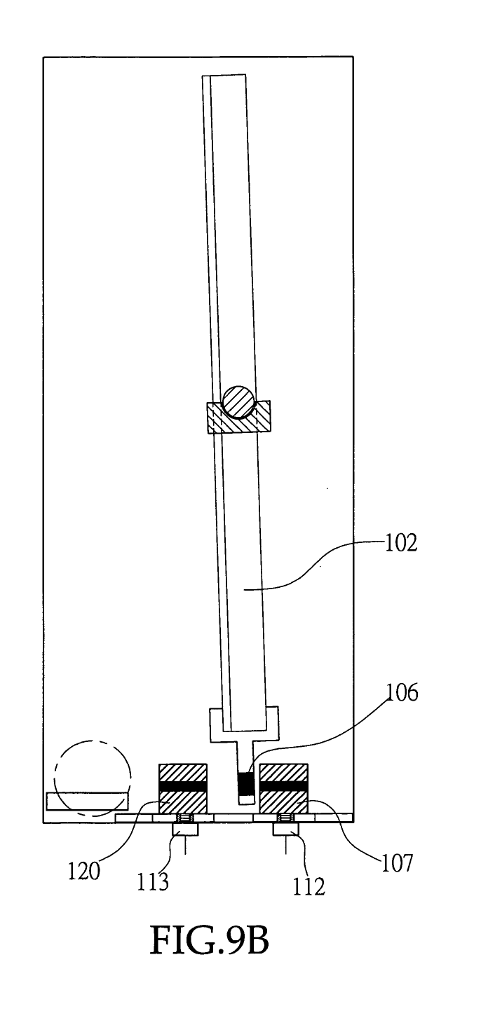

Referring to FIGS. 9A and 9B showing how the first embodiment of an advertisement billboard of the present invention is used to change pictures alternatively, FIG. 9A is assumed that the control circuit board has not yet supplied electric current for the coils 120, 107, the magnet 106 beneath the grating plate 102 adsorbs the left coil 120, if none of the pictures on the grating plate 102 is at a correct completely presenting angular position, the position of the movable screw 113 is micro-adjusted to change the angle of the grating plate 102 carrying pictures, when the movable screw 113 is micro-adjusted to make one of the pictures be at a correct angular position for completely presenting the picture, the movable screw 113 is locked, and a fixed correct angular position can be obtained. Then the magnet 106 beneath the grating plate 102 is moved rightwards to render the magnet 106 to adsorb the other coil 107 such as is shown in FIG. 9B; and then the movable screw 112 is adjusted as the way stated above to get a correct angular position for completely presenting the other picture, now the movable screw 112 is locked, and the other fixed correct angular position can be obtained. At this time, the switch is turned on to render the control circuit board to start to supply electric current for the coils 107 and 120, and the grating plate 102 carrying pictures will move to and fro between the two fixed positions, a person away from the grating plate 102 carrying pictures will then see changing of the different pictures alternatively; just to adjust the control circuit board with an adjustable resistor (not shown), the time that each of the pictures stays for presenting can be obtained.

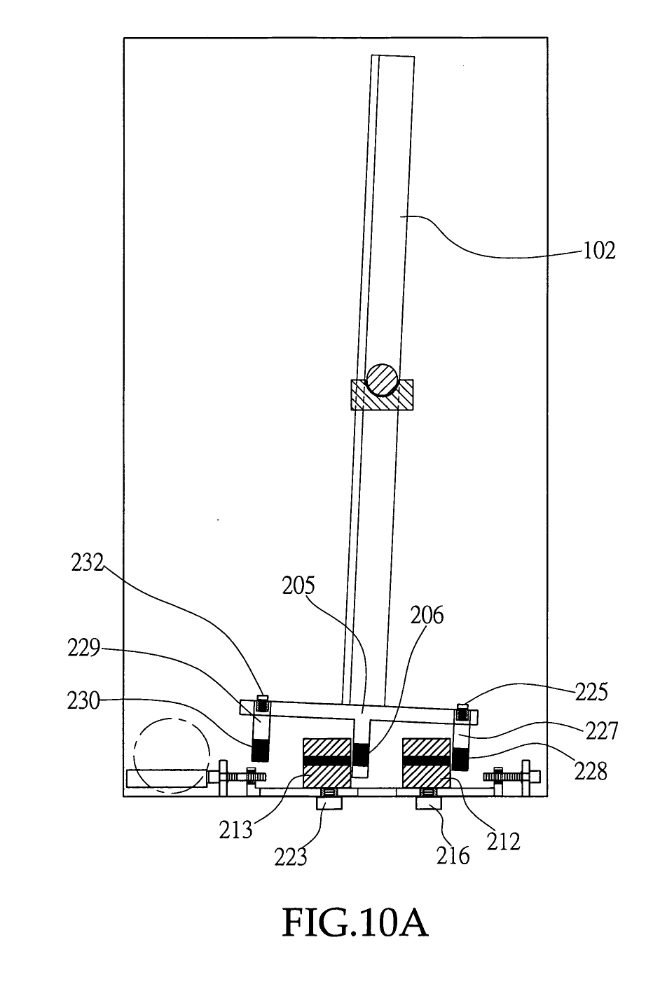

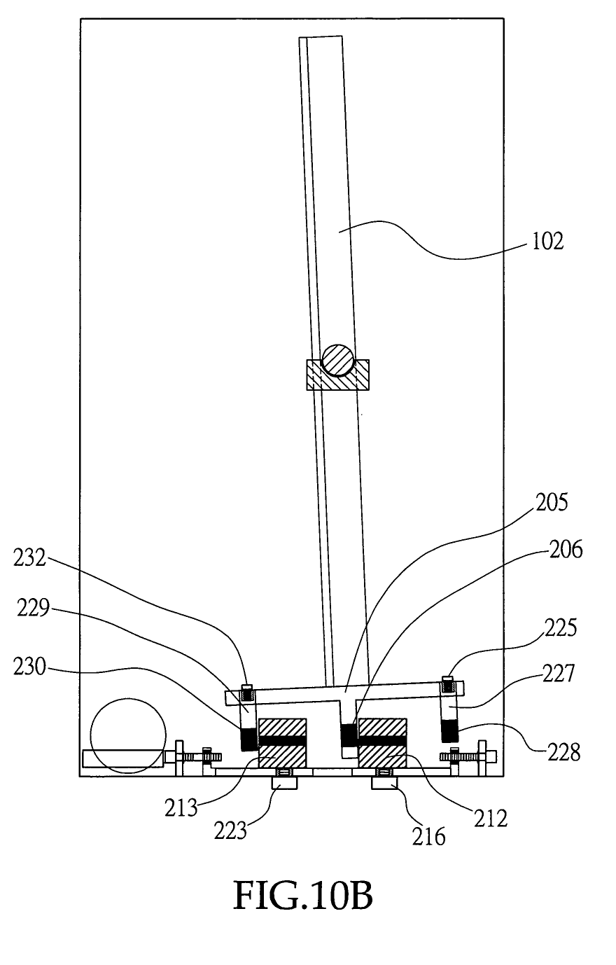

Referring to FIGS. 10A and 10B showing how the second embodiment of an advertisement billboard of the present invention is used to change pictures alternatively, FIG. 10A is assumed that the control circuit board has not yet supplied electric current for the coils 212, 213, the magnet 206 beneath the grating plate 102 adsorbs the left coil 213, if none of the pictures on the grating plate 102 is at a correct completely presenting angular position, the position of the movable screw 223 is micro-adjusted to change the angle of the grating plate 102 carrying pictures, when the movable screw 223 is micro-adjusted to make one of the pictures be at a correct angular position for completely presenting the picture, the movable screw 223 is locked, and a fixed correct position can be obtained. Then the magnet 206 beneath the grating plate 102 is moved rightwards to render the magnet 206 to adsorb the other coil 212 such as is shown in FIG. 10B; and then the movable screw 216 is adjusted as the way stated above to get a fixed correct angular position for completely presenting the other picture, now the movable screw 216 is locked, and the other fixed correct position can be obtained. When both the coils 212, 213 are fixed at their fixed correct angular positions, the movable plain plate 229 is adjusted to exactly contact the coil 213, now the movable screw 223 is locked, and the magnet 206 adsorbs the left coil 213 such as is shown in FIG. 10A; and then the movable plain plate 227 is adjusted to exactly contact the coil 212, the movable screw 225 is locked; it needs only to mount the three magnets 206, 228 and 230 in observance to the directions of magnetic polarities as the way shown in FIG. 8E, at this time, the switch is turned on to render the control circuit board to start to supply electric current for the coils 212, 213, and the grating plate 102 carrying pictures will move to and fro between the two fixed positions, a person away from the grating plate 102 carrying pictures will then see changing of the different pictures alternatively.

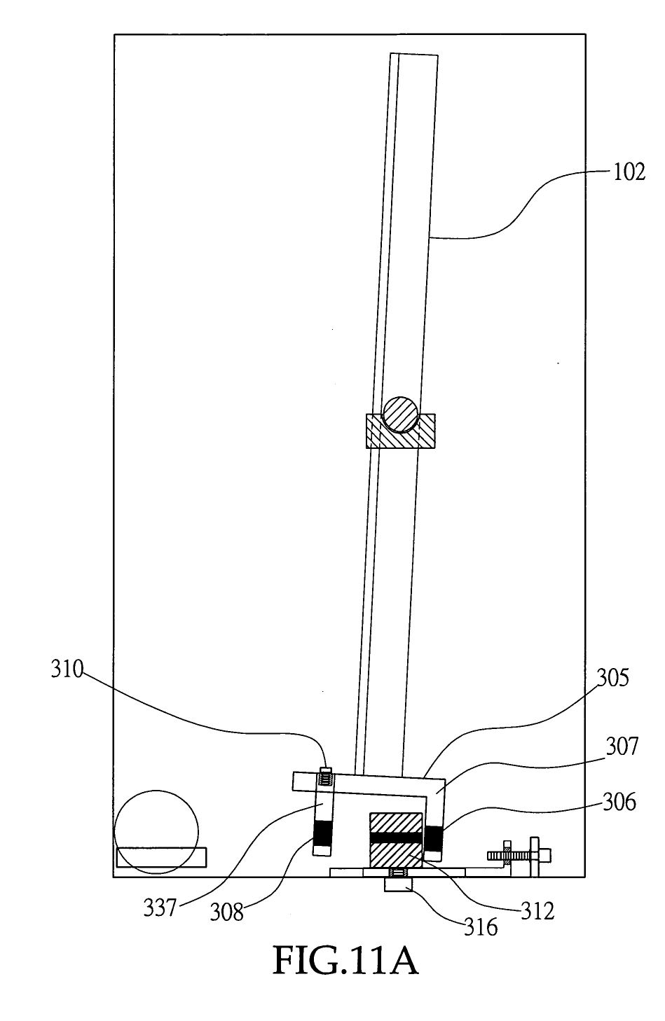

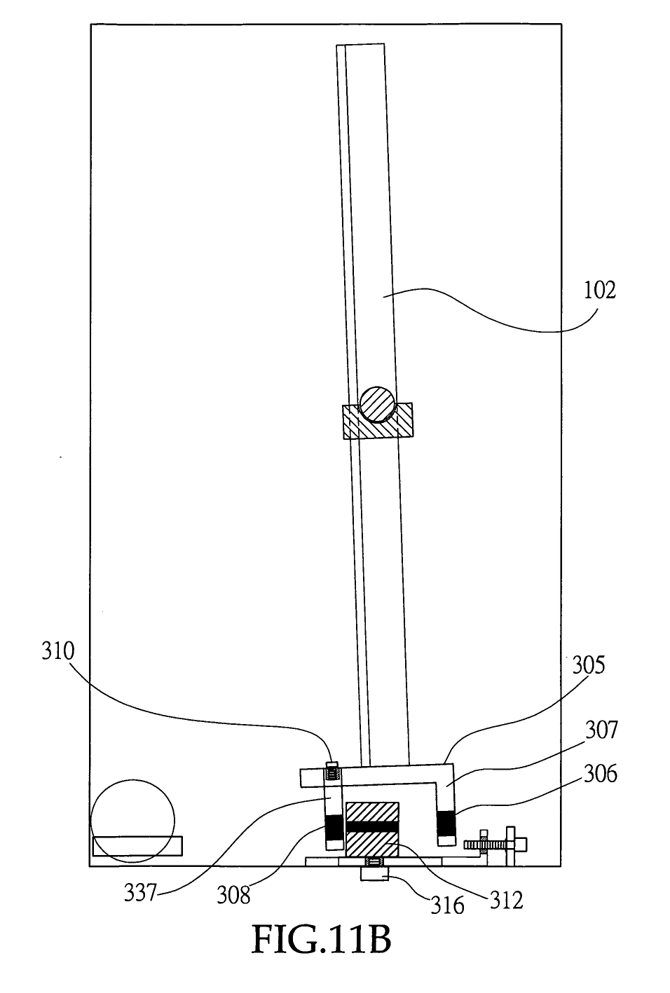

Referring to FIGS. 11A and 11B showing how the third embodiment of an advertisement billboard of the present invention is used to change pictures alternatively, FIG. 11A is assumed that the control circuit board has not yet supplied electric current for the coil 312, the magnet 306 on the “U” shaped plate 305 beneath the grating plate 102 adsorbs the coil 312, if none of the pictures on the grating plate 102 is at a correct completely presenting angular position, the position of the movable screw 316 is micro-adjusted to change the angle of the grating plate 102 carrying pictures, when the movable screw 316 is micro-adjusted to make one of the pictures be at a correct angular position for completely presenting the picture, the movable screw 316 is locked, and a fixed correct position can be obtained. Then the magnet 308 on the movable plain plate 337 on the “U” shaped plate 305 adsorbs the coil 312; the position of the movable screw 310 is micro-adjusted in order that the position that the movable plain plate 337 exactly contacts the coil 312 is exactly the position for completely presenting the other picture, now the movable screw 310 is locked, and the other fixed correct angular position can be obtained. It needs only to mount the two magnets 306, 308 in observance to the directions of magnetic polarities as the way shown in FIG. 8A, at this time, the switch is turned on to render the control circuit board to start to supply electric current for the coil 312, and the grating plate 102 carrying pictures will move to and fro between the two fixed positions, a person away from the grating plate 102 carrying pictures will then see changing of the different pictures alternatively.

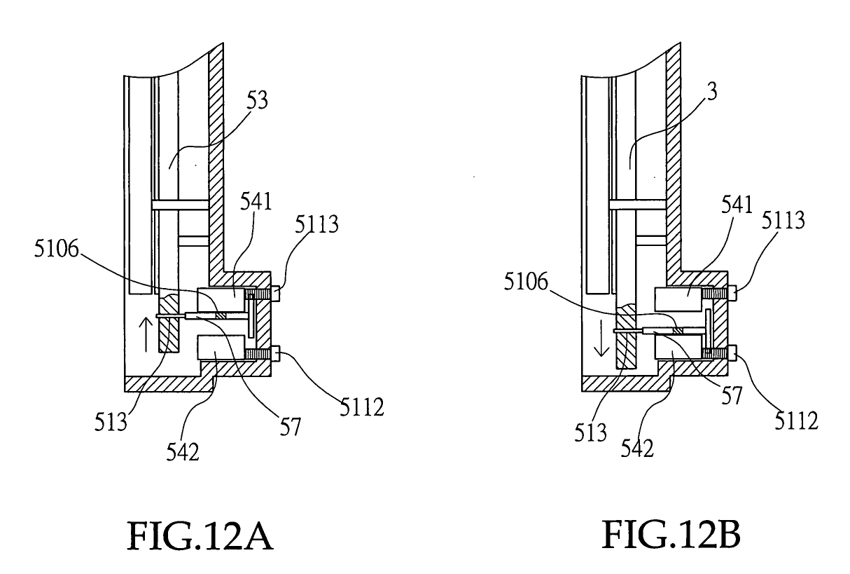

Referring to FIGS. 5A-5E showing how the fourth embodiment of a picture frame of the present invention is used to change two pictures alternatively, when the picture frame has been assembled, micro-adjustment leftwards or rightwards of the screw 517 at an outer position on the bottom of the back plate 51 can be done, and the angular position of the pictures 53 can be changed. When specific veins on the pictures 53 are parallel to those of the grating plate 52, the pictures 53 get their correct angular position, now the screw 517 can be tightened to finish the operation. Further referring to FIGS. 12A and 12B, assuming that the control circuit board has not yet supplied electric current for the coils 541, 542, the magnet 5106 in the middle of the movable plate 57 adsorbs the upper coil 541, if none of the pictures on the grating plate 52 is at a correct completely presenting angular position, the position of a movable screw 5212 is micro-adjusted, thus the protruding cylindrical column 513 on the movable plate 57 moves the pictures 53 to change their positions; when the movable screw 5212 is micro-adjusted to make one of the pictures 53 be at a correct angular position for completely presenting the picture 53, the movable screw 5212 is locked, and a fixed correct angular position can be obtained. Then the movable plate 57 is moved leftwards to make the magnet 5106 adsorb the other coil 542, and then a movable screw 5211 is adjusted as the way stated above to get a correct angular position for completely presenting the other of the pictures 53, now the movable screw 5211 is locked, and the other fixed correct angular position can be obtained. At this time, the switch is turned on to render the control circuit board to start to supply electric current for the coils 541 and 542, and the pictures 53 will move to and fro between the two fixed positions, a person away from the grating plate 52 will then see changing of the different pictures alternatively; just to adjust the control circuit board with an adjustable resistor (not shown), the time that each of the pictures 53 stays for presenting can be obtained.

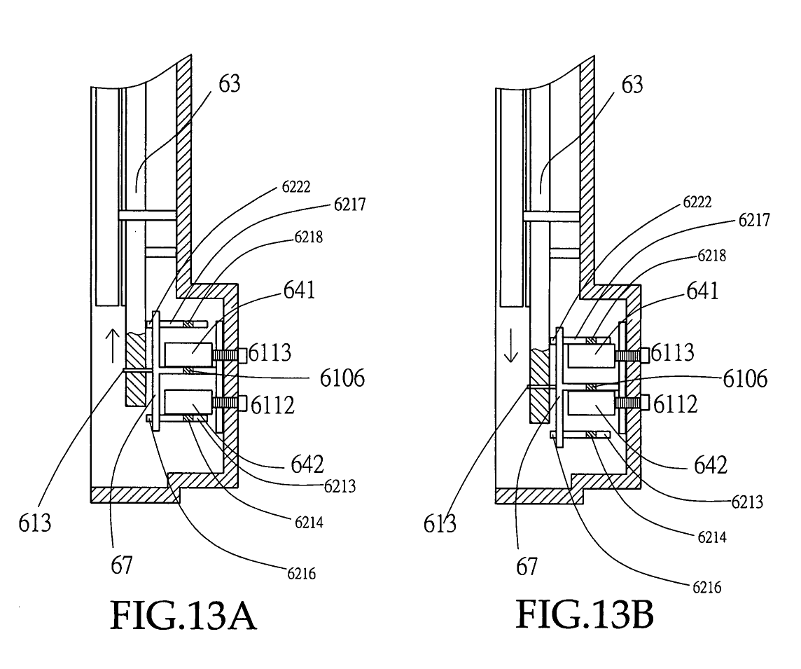

Referring to FIG. 13A showing how the fifth embodiment of a picture frame of the present invention is used to change two pictures alternatively, assuming that the control circuit board has not yet supplied electric current for the coils 641, 642, the magnet 6106 in the middle of the “E” shaped movable plate 67 adsorbs the upper coil 641, if none of the pictures on the grating plate 62 is at a correct completely presenting angular position, the position of a movable screw 6113 is micro-adjusted, thus the protruding cylindrical column 613 on the movable plate 67 moves the pictures 63 to change their positions; when the movable screw 6113 is micro-adjusted to make one of the pictures 63 be at a correct angular position for completely presenting the picture 63, the movable screw 6113 is locked, and a fixed correct angular position can be obtained. Then the movable plate 67 is moved downwards to make the magnet 6106 adsorb the other coil 642 such as is shown in FIG. 13B; and then a movable screw 6112 is adjusted as the way stated above to get a correct angular position for completely presenting the other of the pictures 63, now the movable screw 6112 is locked, and the other fixed correct angular position can be obtained. When both the coils 641, 642 are fixed at their fixed correct angular positions, the movable plain plate 6217 is adjusted to exactly contact the coil 641, now the movable screw 6222 is locked, and the magnet 6106 adsorbs upwardly the coil 641 such as is shown in FIG. 13A; and then the movable plain plate 6213 is adjusted to exactly contact the coil 642, the movable screw 6216 is locked; it needs only to mount the three magnets 6106, 6214 and 6218 in observance to the directions of magnetic polarities as the way shown in FIG. 8E, at this time, the switch is turned on to render the control circuit board to start to supply electric current for the coils 641, 642, and the pictures will move to and fro between the two fixed positions, a person away from the grating plate 102 carrying pictures will naturally see changing of the different pictures alternatively.

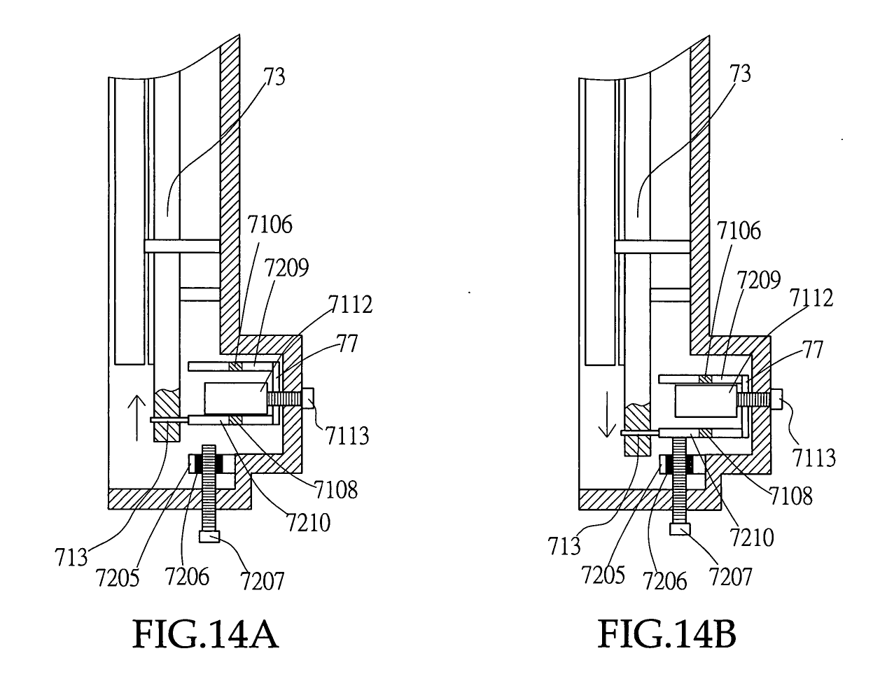

Referring to FIG. 14A showing how the sixth embodiment of a picture frame of the present invention is used to change two pictures alternatively, assuming that the control circuit board has not yet supplied electric current for the coil 7112, the magnet 7108 on the movable “U” shaped plate 77 formed by combining of two plain plates 7209, 7210 adsorbs the coil 7112, if none of the pictures on the grating plate 72 is at a correct completely presenting angular position, the position of the movable screw 7113 is micro-adjusted, thus the protruding cylindrical column 713 changes the positions of the pictures 73; when the movable screw 7113 is micro-adjusted to make one of the pictures 73 be completely presented, the movable screw 7113 is locked, and a fixed correct position can be obtained. Then the movable “U” shaped plate 77 is moved downwards to make the magnet 7106 on the plain plate 7209 adsorb the coil 7112; at this time, if the other picture on the grating plate 72 is not at a correct angular position for completely presenting the picture, the movable screw 7113 is micro-adjusted to make a movable screw 7027 be micro-adjusted to make the other picture on the grating plate 72 be exactly at the correct angular position for completely presenting the picture such as is shown in FIG. 14B; and the other fixed correct angular position can be obtained. It needs only to mount the two magnets 7106 and 7108 in observance to the directions of magnetic polarities as the way shown in FIG. 8A, at this time, the switch is turned on to render the control circuit board to start to supply electric current for the coil 7112, and the pictures will move to and fro between the two fixed positions, a person away from the grating plate 72 carrying pictures will then see changing of the different pictures alternatively.

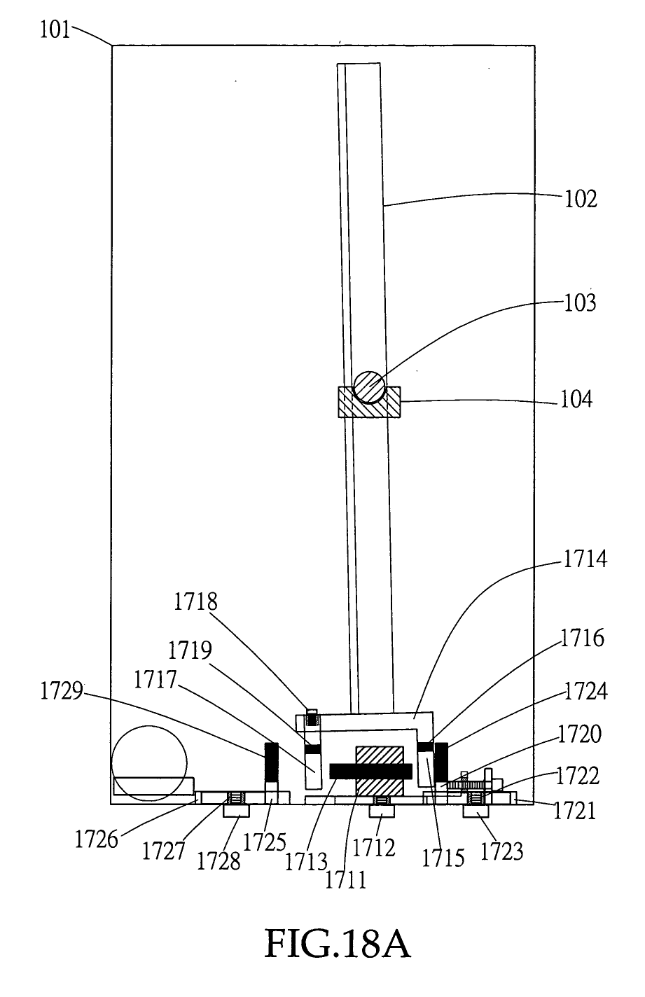

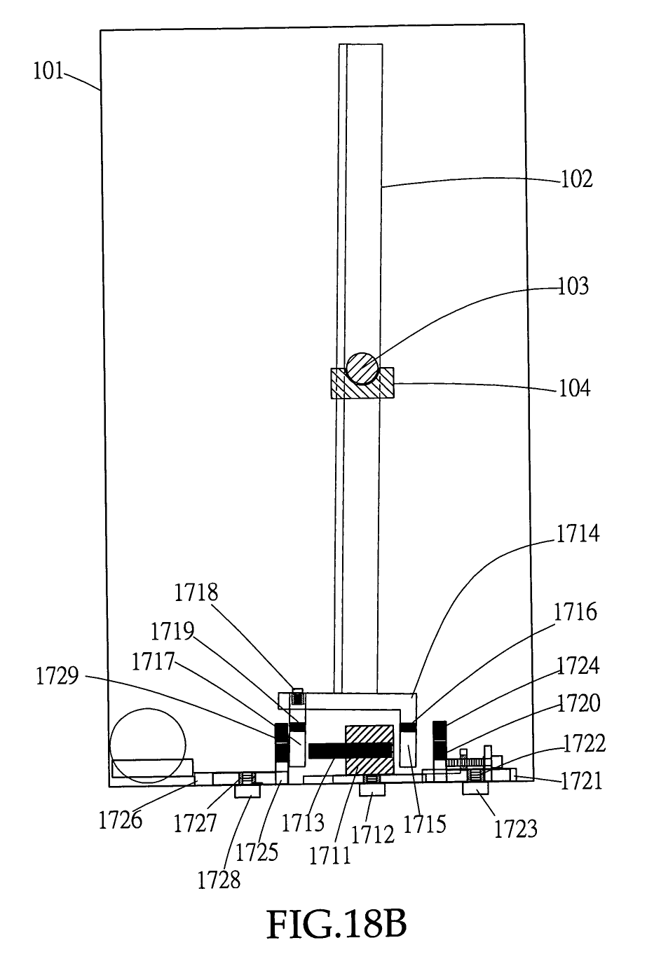

Referring to FIG. 18A showing how the eighth embodiment of an advertisement billboard of the present invention is used to change pictures alternatively, assuming that the control circuit board has not yet supplied electric current for the coil 1711, the fixed magnet 1716 on the fixed plain plate 1715 of the “U” shaped plate 1714 adsorbs the iron sheet 1724 on the “L” shaped movable plate 1720, at this time, if none of the pictures on the grating plate 102 is at a correct completely presenting angular position, the position of the movable screw 1723 is micro-adjusted, the grating plate 102 naturally changes its angular position, when the movable screw 1723 is micro-adjusted to make one of the pictures be completely presented, the movable screw 1723 is locked, and a fixed correct position can be obtained. Please refer to FIG. 18B, then a movable screw 1718 is adjusted to make the distance between the movable plain plate 1717 and the fixed plain plate 1715 equals to the length of the magnet 1713 plus an appropriate distance, and the movable screw 1718 is locked, the “U” shaped plate 1714 is moved upwards to render the fixed magnet 1719 to adsorb the iron sheet 1729 on the “L” shaped movable plate 1725; at this time, if the other picture on the grating plate 102 is not at a correct angular position for completely presenting the picture, the movable screw 1728 is micro-adjusted, then the angular position of the grating plate 102 is naturally changed, when the movable screw 1728 is micro-adjusted to make the other picture be completely presented, the movable screw 1728 is locked, and the other fixed correct angular position can be obtained. The two magnets 1716, 1719 fixed on the “U” shaped plate 1714 adsorb the iron sheets 1724, 1729 on the “L” shaped movable plate 1725 to only have a function to keep the grating plate 102 at a given angular position, their magnetic forces are designed to be constantly smaller than the rushing force generated by the magnet 1713; while the iron sheets 1724, 1729 on the “L” shaped movable plate 1725 renders the range of adsorbing area of the magnet 1713 designed to be smallest which is sufficient to make the magnet 1713 unmoved. The adsorbing force of magnet 1713 to the iron sheets 1724, 1729 is also designed to be constantly smaller than the rushing force generated by the magnet 1713; the position of the adjusting screw 1712 can change the position of the coil 1711 to in turn change the ratio of range of the N polarity to S polarity in the magnet 1713, and the rushing force generated by the magnet 1713 can be changed, yet which one of the forces of it towards the left and the right is larger can be controlled. At this time, the switch is turned on to render the control circuit board to start to supply electric current for the coil 1711, and the grating plate 102 with the pictures will move to and fro between the two fixed positions, a person away from the grating plate 102 carrying pictures will naturally see changing of the different pictures alternatively.

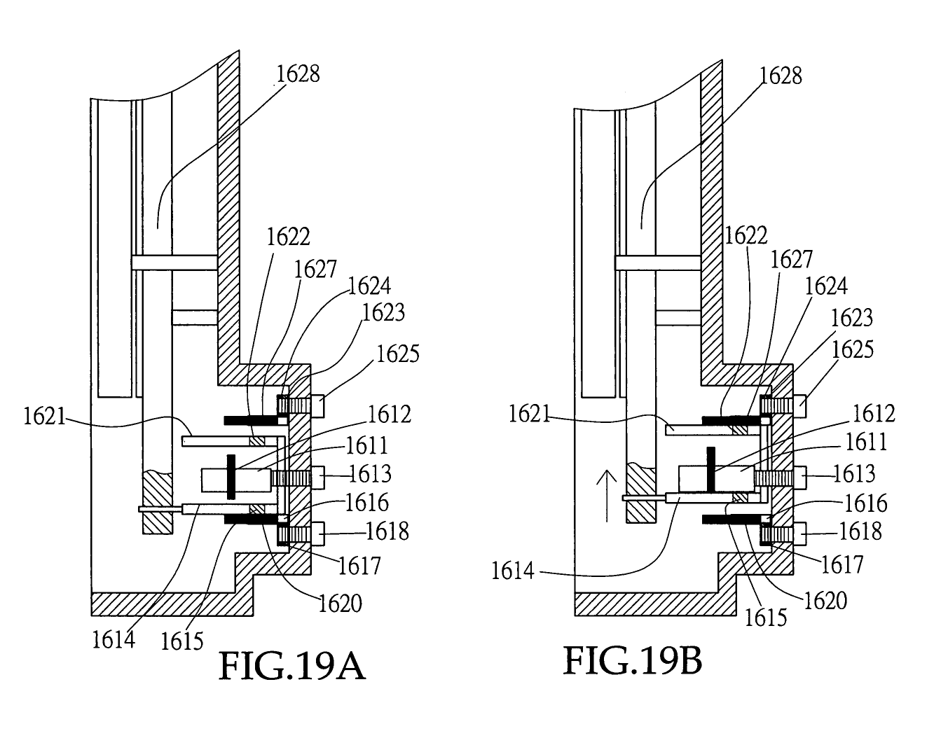

Referring to FIG. 19A showing how the seventh embodiment of a picture frame of the present invention is used to change two pictures alternatively, assuming that the control circuit board has not yet supplied electric current for the coil 1611, the fixed magnet 1615 on the fixed plain plate 1614 of the “U” shaped plate adsorbs the iron sheet 1620 on the left “L” shaped movable plate 1616, at this time, if none of the pictures on the grating plate is at a correct completely presenting angular position, the position of the movable screw 1618 is micro-adjusted, the position of a plain plate 1628 having pictures thereon naturally changes, when the movable screw 1618 is micro-adjusted to make one of the pictures be completely presented, the movable screw 1618 is locked, and a fixed correct position can be obtained. Please refer to FIG. 19B, then the “U” shaped movable plate is moved right to make the magnet 1622 on the upper plain plate 1621 at the right side of the “U” shaped plate adsorbs the iron sheet 1627 on the “L” shaped movable plate 1623; at this time, if the other picture on the grating plate is not at a correct angular position for completely presenting the picture, the movable screw 1625 is micro-adjusted, then the position of the plain plate 1628 having pictures thereon is naturally changed; when the movable screw 1625 is micro-adjusted to make the other picture be completely presented, the movable screw 1625 is locked, and the other fixed correct angular position can be obtained. The two magnets 1615 and 1612 fixed on the “U” shaped plate adsorb the iron sheets 1620, 1627 on the “L” shaped movable plate 1623 to only have a function to keep the grating plate at a given angular position, their magnetic forces are designed to be constantly smaller than the rushing force generated by the magnet 1612; while the iron sheets 1620, 1627 on the “L” shaped movable plate 1623 renders the range of adsorbing area of the magnet 1612 designed to be smallest which is sufficient to make the magnet 1612 unmoved. The adsorbing force of the magnet 1612 to the iron sheets 1620, 1627 is also designed to be constantly smaller than the rushing force generated by the magnet 1612; the position of the adjusting screw 1613 can change the position of the coil 1611 to in turn change the ratio of range of the N polarity to S polarity in the magnet 1612, and the rushing force generated by the magnet 1612 can be changed, yet which one of the forces of it towards the left and the right is larger can be controlled. At this time, the switch is turned on to render the control circuit board to start to supply electric current for the coil 1611, and the grating plate with the pictures will move to and fro between the two fixed positions, a person away from the grating plate carrying pictures will naturally see changing of the different pictures alternatively.

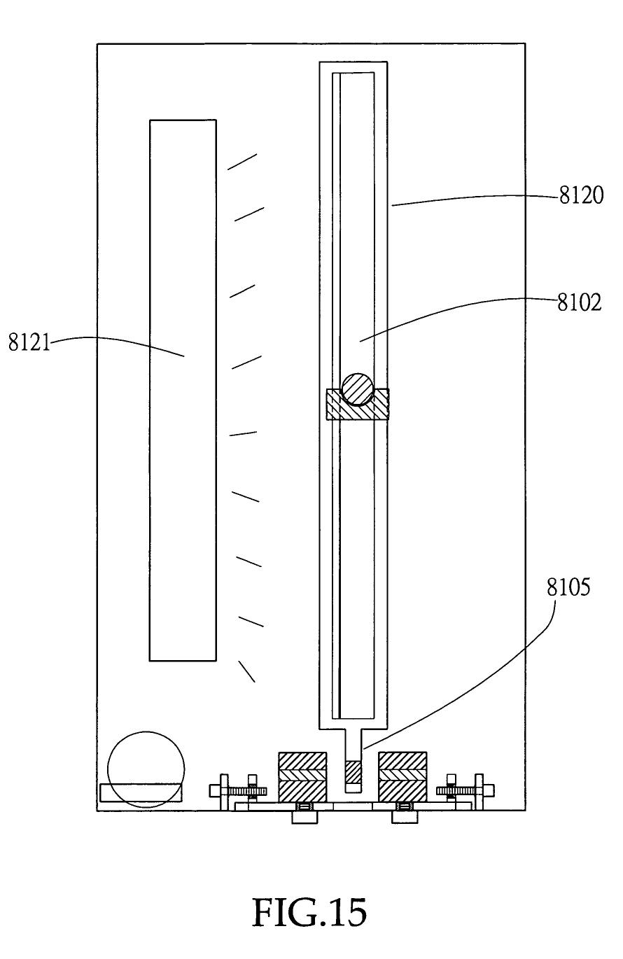

Certainly, light emitting elements can be installed under the pictures in a picture frame or an advertisement billboard, such as is depicted in FIG. 15 having a light emitting element 8121 which is suitable for a lamp case used at night or in the dark, these all fall into the scope of the present invention.

In the embodiment of an advertisement billboard used as a large scale advertisement billboard shown in FIG. 15, a plain plate 8105 has thereabove a framework 8120 that can frame four edges and a back side of a grating plate 8102 and has on two lateral sides thereof protruding cylindrical columns; the front face of the framework 8120 can be mounted with a transparent glass or plastic panel (not shown) to press flat the pictures on the grating plate 8102 to be fixed by the framework 8120, in order that the plain plate 8105 can move the grating plate 8102 carrying the pictures with a sufficient force.

In conclusion, the brand-new structures of a picture frame and an advertisement billboard for two pictures changing at fixed positions provided by the present invention can surely achieve the expected object thereof to get the effect that the two pictures are entirely presented in prolonged times.

Having thus described the technical structure of my invention with practicability and improvement, what I claim as new and desire to be secured by Letters Patent of the United States is:

1. A display frame for two pictures changing at fixed positions, said display frame comprises a framework, two pictures, a grating plate, at least a magnet, an electric power source, a control circuit board and at least a coil; said pictures and said grating plate are assembled in said framework, at least said pictures or said grating plate is connected to a plain plate fixed thereon with said magnet, said display frame is characterized in that: said control circuit board controls said coil to generate a specific magnetic force for moving said magnet, and angular positions of said pictures and said grating plate are changed, thereby effects that said two pictures are automatically changed and entirely presented in prolonged times are achieved.

2. The display frame for two pictures changing at fixed positions as claimed in claim 1, wherein said display frame is a picture frame, said framework further comprises a back plate, said pictures and said grating plate in said framework are separately mounted; after said pictures are stuck onto a movable plain plate, they are placed beneath said grating plate and on a plurality of protruding cylindrical columns to be adjusted in position to get higher or lower with a plurality of movable screws, said grating plate is fixed on said framework, a notch on a top of said plain plate is slipped over another protruding cylindrical column on a slide plate in said back plate, said slide plate is mounted in two protruding rails on said back plate, a fixing nut is provided on said slide plate and is locked therein with a screw which is extended from outside of said back plate; said slide plate has a function of adjusting and fixing said pictures; said at least a coil is provided in said framework and is fixed respectively on at least a movable slide plate and is mounted in other two protruding rails fixed on said framework, said at least a movable slide plate has at least a nut respectively fixed on their bottoms, a plurality of movable screws are extended from outside of said framework and are locked in said nuts to control respective positions of said at least a coil to be fixed; a further protruding cylindrical column is provided on a top of a movable plate which is connected with said plain plate stuck with said pictures, at least a magnet is provided on said movable plate; said movable plate is mounted and fixed in said other two protruding rails on said back plate to limit its direction of movement.

3. The display frame for two pictures changing at fixed positions as claimed in claim 2, wherein said movable plate which is connected with said plain plate stuck with said pictures is a “U” shaped plate which is provided at its two lateral sides each with a fixed plain plate each has thereon a magnet, said “U” shaped plate is mounted in the middle of it with a coil, said magnets on said two lateral sides of said movable plate with same polarity both face to said coil in the middle, a movable screw is extended laterally from outside through said back plate into a nut fixed on a protruding rectangular sheet protruding out of said back plate for controlling positioning of said “U” shaped plate.

4. The display frame for two pictures changing at fixed positions as claimed in claim 2, wherein said movable plate which is connected with said plain plate stuck with said pictures is an “E” shaped plate which is provided at its middle with a fixed plain plate having thereon a magnet, and which is provided at its two lateral sides each with a movable plain plate fixed thereon with a magnet and a nut, two movable screws are respectively locked into said nuts, said middle fixed plain plate is provided between it and said two lateral movable plain plates respectively with two coils, polarities of said magnets on said two lateral movable plain plates both facing to said coils are same as that of an end of said magnet in opposition thereto on said middle fixed plain plate.

5. The display frame for two pictures changing at fixed positions as claimed in claim 2, wherein said movable plate which is connected with said plain plate stuck with said pictures is a plain plate having thereon a magnet, said magnet is provided at its lateral sides each with a coil.

6. The display frame for two pictures changing at fixed positions as claimed in claim 2, wherein said pictures installed in said framework are fixed in said framework, said grating plate installed in said framework is connected with said movable plate having a magnet fixed thereon for moving.

7. The display frame for two pictures changing at fixed positions as claimed in claim 1, wherein said framework is mounted therein with light emitting elements and elements such as electric power lines, transformers and switches etc. necessary for said light emitting elements.

8. The display frame for two pictures changing at fixed positions as claimed in claim 1, wherein said display frame is an advertisement billboard; and wherein said grating plate and pictures are assembled integrally and are hung on two semicircle recessed supporting seats inside of said framework with two clamping means each having a round axle, said framework is mounted on its bottom with said at least a coil fixed on a movable slide plate of which a bottom has a nut fixed thereon, said movable slide plate is mounted and fixed in two protruding rails on said framework to limit its direction of movement; a movable screw is extended from outside of said bottom of said framework through a rectangular hole of said framework to be locked in said nut of said movable slide plate; the position of said coil is adapted to being adjusted by moving said movable screw, a plain plate is connected to said grating plate and is fixed thereon with at least a magnet.

9. The display frame for two pictures changing at fixed positions as claimed in claim 8, wherein said plain plate connected to said grating plate is a “U” shaped plate with a fixed plain plate on its one end having thereon a fixed magnet, said “U” shaped plate is provided on its other end with a movable plain plate also having thereon a fixed magnet, said movable plain plate has thereon a fixed nut, a movable screw is locked in said nut, said “U” shaped plate is mounted in the middle of it with a coil, said magnets on two lateral sides of said plain plate with same polarity both face to said coil in the middle.

10. The display frame for two pictures changing at fixed positions as claimed in claim 8, wherein said plain plate connected to said grating plate is an “E” shaped plate with a fixed plain plate in the middle of it and with a fixed magnet thereon, said “E” shaped plate is provided on its two ends each with a movable plain plate which is fixed thereon with a magnet and a nut locked therein with a movable screw, said middle fixed plain plate is provided between it and said two lateral movable plain plates respectively with two coils, polarities of said magnets on said two lateral movable plain plates both facing to said coils are same as that of an end of said magnet in opposition thereto on said middle fixed plain plate.

11. The display frame for two pictures changing at fixed positions as claimed in claim 8, wherein said plain plate which is connected with said grating plate is a plain plate having thereon a fixed magnet, said magnet is provided at their lateral sides each with a coil.

12. The display frame for two pictures changing at fixed positions as claimed in claim 8, wherein said movable slide plate fixed with said at least a coil is provided on one end thereof with a nut, a movable screw is extended from a stub protruding out of said framework to be locked in said nut; a “C” shaped annulus grips said movable screw on one side of said stub; said coil is adapted to being adjusted by rotating said movable screw.

13. The display frame for two pictures changing at fixed positions as claimed in claim 8, wherein said plain plate which is connected with said grating plate has thereabove another framework that frames four edges and a back side of said grating plate, said another framework has on and in the middle of two lateral sides thereof protruding cylindrical columns; a front face of said another framework is mounted with a transparent glass or plastic panel to press flat said pictures on said grating plate to be fixed by said another framework.

14. The display frame for two pictures changing at fixed positions as claimed in claim 1, wherein said electric power source for supplying for said control circuit board is a battery or an alternative electric power source obtained through a transformer.

15. The display frame for two pictures changing at fixed positions as claimed in claim 1, wherein said at least a coil is a magnetism conductive coil made from iron sheets, silicon steel sheets or a magnet.

16. The display frame for two pictures changing at fixed positions as claimed in claim 3, wherein said coil mounted in the middle of said “U” shaped plate has in the middle of it a movable cylindrical magnet, said “U” shaped plate has two “L” shaped movable plates respectively on its two lateral sides, said “L” shaped movable plates each is mounted respectively in two protruding rails protruding out of said back plate, each of said “L” shaped movable plates has a nut fixed thereon, said “L” shaped movable plates each has an iron sheet fixed at its lateral side, two movable screws are extended from a bottom of and through said back plate into said nuts fixed on said “L” shaped movable plates for controlling positioning of said “U” shaped plate.

17. The display frame for two pictures changing at fixed positions as claimed in claim 9, wherein a “U” shaped plate has in the middle of it a coil, said coil has in the middle of it a movable cylindrical magnet, said “U” shaped plate has two “L” shaped movable slide plates respectively on its two lateral sides, said “L” shaped movable slide plates each is mounted respectively in two protruding rails protruding out of said framework, each of said “L” shaped movable slide plates has a nut fixed thereon, said “L” shaped movable slide plates each has an iron sheet fixed at its lateral side, two movable screws are extended from a bottom of and through said framework into said nuts fixed on said “L” shaped movable slide plates for controlling positioning of said “U” shaped plate.

18. The display frame for two pictures changing at fixed positions as claimed in claim 1, wherein said grating plate is a cylindrical mirror type grating plate or a grating plate formed by sticking of a printing type grating plate to transparent material.
